(19) United States
(12) Patent Application Publication
(10) Pub. No.: US 2025/0239702 A1
(43) Pub. Date: Jul. 24, 2025

(54) ENERGY STORAGE SYSTEM

(71) Applicant: Jinko Energy Storage Technology Co., Ltd., Haining City (CN)

(72) Inventors: Xiang WANG, Haining City (CN); Guochao CHEN, Haining City (CN); Shaorong GE, Haining City (CN)

(21) Appl. No.: 18/740,421

(22) Filed: Jun. 11, 2024

(30) Foreign Application Priority Data
Jan. 24, 2024 (CN) 202410105438.X
Jan. 25, 2024 (CN) 202410105774.4

(51) Int. Cl. H01M 50/204; A62C 3/16; H01M 10/613; H01M 10/627; H01M 10/6568; H01M 50/251; H01M 50/258; H01M 50/298

(52) U.S. Cl. CPC H01M 50/204; A62C 3/16; H01M 10/613; H01M 10/627; H01M 10/6568; H01M 50/251; H01M 50/258; H01M 50/298; H01M 2220/10

(57) ABSTRACT

Embodiments of the present disclosure relate to the field of energy storage and provide an energy storage system, including: a main body and a plurality of battery modules. The main body includes an equipment compartment and a battery compartment arranged in a first direction. The equipment compartment is configured to accommodate at least one of a fire protection device, an electrical integrated cabinet, and a liquid cooling unit, and the battery compartment is configured to accommodate the plurality of battery modules. The plurality of battery modules are arranged in the battery compartment and arranged at intervals along the first direction, and each battery module of the plurality of battery modules extends along a second direction. The first direction refers to a length direction of the energy storage system, and the second direction refers to a width direction of the energy storage system.

### CROSS REFERENCE TO RELATED APPLICATIONS

The present application claims the benefit of priority under the Paris Convention to Chinese Patent Application No. 202410105774.4 filed on Jan. 25, 2024, and to Chinese Patent Application No. 202410105438.X filed on Jan. 24, 2024, each of which is incorporated herein by reference in its entirety.

### TECHNICAL FIELD

Embodiments of the present disclosure relate to the field of energy storage, and in particular to an energy storage system.

### BACKGROUND

Large-scale chemical battery energy storage systems, such as energy storage power stations, energy storage containers, and industrial and commercial energy storage facilities, require the arrangement of energy storage batteries, battery racks, fire protection devices, electrical integrated cabinets, liquid cooling units, cooling and dehumidification equipment, and the like in limited space, and have characteristics such as high voltage of battery modules, large number of battery cells, large space occupied by battery modules, and the like. At present, special containers are often used as containers for arranging battery modules and frequency converters. Energy storage containers are different from ordinary freight containers. Usually, in addition to consideration of the load bearing capacity and the integration density of components, it is necessary to consider the coordination relationship between various components, such as the coordination relationship between battery modules and doors of battery compartments, and doors of battery compartments and bodies of containers, in order to facilitate the installation or maintenance of the components. In related technologies, layouts of internal space of energy storage systems often face problems such as unreasonable layout, low space utilization, low energy density, difficulty in heat dissipation, and the like.

Therefore, it is necessary to provide an energy storage system to address at least some of the aforementioned problems.

### SUMMARY

Embodiments of the present disclosure provide an energy storage system, which is at least conducive to compact arrangement of a fire protection device, an electrical integrated cabinet, and a liquid cooling unit, in order to expand the volume of a battery compartment and thus facilitate increase of the amount of a plurality of battery modules that can be accommodated in the battery compartment.

Some embodiments of the present disclosure provide an energy storage system, including a main body and a plurality of battery modules. The main body includes an equipment compartment and a battery compartment arranged in a first direction. The equipment compartment is configured to accommodate at least one of a fire protection device, an electrical integrated cabinet, and a liquid cooling unit, and the battery compartment is configured to accommodate the plurality of battery modules. The plurality of battery modules are arranged in the battery compartment. The plurality of battery modules are arranged at intervals along the first direction and each battery module of the plurality of battery modules extends along a second direction. The first direction refers to a length direction of the energy storage system, and the second direction refers to a width direction of the energy storage system.

In some embodiments, in the first direction, the equipment compartment has a first size, the battery compartment has a second size, and a ratio of the first size to the second size ranges from 0.06 to 0.16.

In some embodiments, the first size ranges from 0.4 m to 0.7 m, and the second size ranges from 4.5 m to 6 m.

In some embodiments, in the second direction, a length of one respective battery module of the plurality of battery modules is less than a width of the battery compartment by 100 mm to 250 mm; and in the first direction, a sum of widths of the plurality of battery modules is less than a length of the battery compartment.

In some embodiments, the equipment compartment includes a first compartment and a second compartment arranged along the second direction, the first compartment is configured to accommodate the fire protection device and the electrical integrated cabinet, and the second compartment is configured to accommodate the liquid cooling unit.

In some embodiments, the fire protection device and the electrical integrated cabinet are spaced from each other in a third direction, and the third direction refers to a height direction of the energy storage system.

In some embodiments, the energy storage system further includes a plurality of high-voltage compartments arranged below the plurality of battery modules in a third direction and electrically connected to the plurality of battery modules. The third direction refers to a height direction of the energy storage system. Each battery module of the plurality of battery modules corresponds to one or two respective high-voltage compartments of the plurality of high-voltage compartments.

In some embodiments, each battery module of the plurality of battery modules corresponds to two respective high-voltage compartments of the plurality of high-voltage compartments and includes a first submodule and a second submodule arranged in the third direction, the first submodule is electrically connected to one high-voltage compartment of the two respective high-voltage compartments, and the second submodule is electrically connected to an other high-voltage compartment of the two respective high-voltage compartments.

In some embodiments, each battery module of the plurality of battery modules corresponds to one respective high-voltage compartment of the plurality of high-voltage compartments and includes a first submodule and a second submodule arranged in the third direction. The one respective high-voltage compartment has a first input and output port and a second input and output port arranged on a side of the one respective high-voltage compartment extending perpendicular to the second direction, and the first input and output port and the second input and output port are spaced from each other.

In some embodiments, the energy storage system further includes liquid cooling pipelines arranged on a side of the battery compartment extending perpendicular to the second direction.

In some embodiments, in a third direction, each battery module of the plurality of battery modules has a bottom side and a top side, where the third direction refers to a height direction of the energy storage system. The liquid cooling pipelines include a main inflow pipeline and a main outflow pipeline, and in the third direction, one of the main inflow pipeline and the main outflow pipeline is arranged on the bottom side and has a part facing towards the bottom side, and an other of the main inflow pipeline and the main outflow pipeline is arranged on the top side and has a part facing towards the top side. The main inflow pipeline has an inlet, the main outflow pipeline has an outlet, and the inlet and the outlet are connected to the liquid cooling unit.

In some embodiments, the liquid cooling unit includes a first portion and a second portion arranged along the third direction, the first portion includes a plurality of air exhaust devices, and the second portion is connected with the inlet of the main inflow pipeline and the outlet of the main outflow pipeline.

In some embodiments, the second portion has a sidewall extending perpendicular to the first direction, there is a gap between the sidewall and a bottom of the main body in the third direction, and the gap is formed on a side of the main body perpendicular to the first direction. The energy storage system further includes a decorative panel configured to block the gap.

In some embodiments, each of the plurality of battery modules includes a plurality of battery unit stacked along a third direction, and the third direction refers to a height direction of the energy storage system.

In some embodiments, the energy storage system further includes a plurality of brackets configured to carry battery units of the plurality of battery modules and extending in the second direction, wherein each battery unit of the battery units is arranged on two respective brackets of the plurality of brackets spaced from each other in the first direction.

In some embodiments, a plurality of cable grooves are defined in the main body and include bottom cable grooves that are defined at a bottom of the battery compartment in a third direction, and the third direction refers to a height direction of the energy storage system.

In some embodiments, the bottom cable grooves include first cable grooves and second cable grooves, and the first cable grooves are spaced from the second cable grooves. The energy storage system further includes: first cables arranged in the first cable grooves, where the first cables are used to conduct dynamic electricity; and second cables arranged in the second cable grooves, where the second cables are used to transmit signals.

Embodiments of the present disclosure provide another energy storage system, which is at least conducive to decrease of the number of doors for the battery compartment, thereby reducing the space reserved in the main body for hinge connection of the doors for the battery compartment, and increasing the space in the main body for arranging the plurality of battery modules.

Some embodiments of the present disclosure provide an energy storage system, including a main body including a battery compartment configured to accommodate a plurality of battery modules, the plurality of battery modules arranged in the battery compartment, and a plurality of doors for the battery compartment. The plurality of battery modules are arranged at intervals along a first direction or a second direction, where the first direction refers to a length direction of the energy storage system, and the second direction refers to a width direction of the energy storage system. Each door for the battery compartment of the plurality of doors for the battery compartment is arranged on one respective side of two sides of the main body perpendicular to the second direction, and is hinged to the main body. In the second direction, each door for the battery compartment of the plurality of doors for the battery compartment corresponds to and faces towards at least one respective battery module of the plurality of battery modules.

In some embodiments, the plurality of battery modules include a first module group and a second module group, battery modules of the first module group are arranged at intervals along the first direction, and battery modules of the second module group are arranged at intervals along the second direction.

In some embodiments, the plurality of battery modules are arranged at intervals along only the first direction.

In some embodiments, the plurality of doors for the battery compartment are arranged on a same side of the two sides of the main body perpendicular to the second direction.

In some embodiments, each battery module of the plurality of battery modules includes a plurality of battery packs stacked along a third direction, and each battery pack of the plurality of battery packs includes a single first storage battery module or two second storage battery modules arranged along the second direction. The third direction refers to a height direction of the energy storage system.

In some embodiments, the main body includes a plurality of brackets and a plurality of columns defining accommodating space in the main body. In the third direction, each column of the plurality of columns has two respective brackets of the plurality of brackets mounted at two ends of the each column, respectively, and corresponds to a respective door for the battery compartment of the plurality of doors for the battery compartment having a lateral edge hinged to the each column. The third direction refers to a height direction of the energy storage system.

In some embodiments, in the first direction, a first distance between each two adjacent battery modules of the plurality of battery modules that are separated by a respective column of the plurality of columns and correspond to different doors for the battery compartment, respectively, is greater than or equal to a second distance between each two adjacent battery modules of the plurality of battery modules that are not separated by any column.

In some embodiments, the first distance ranges from 60 mm to 150 mm, and the second distance ranges from 30 mm to 150 mm.

In some embodiments, in the first direction, each column of the plurality of columns that is hinged with a respective door for the battery compartment of the plurality of doors for the battery compartment has a first width, each column of the plurality of columns that is not hinged with any of the plurality of doors for the battery compartment has a second width, and the first width is greater than or equal to the second width.

In some embodiments, the first width ranges from 60 mm to 150 mm, and the second width ranges from 22 mm to 142 mm.

In some embodiments, in the second direction, each door for the battery compartment of the plurality of doors for the battery compartment corresponds to and faces towards N respective battery modules of the plurality of battery modules, where N is a rational number greater than or equal to 1. In the second direction, a number of battery modules of the plurality of battery modules corresponding to one respective door for the battery compartment of the plurality of doors for the battery compartment is different from a number of battery modules of the plurality of battery modules corresponding to another door for the battery compartment of the plurality of doors for the battery compartment, or in the second direction, a number of battery modules of the plurality of battery modules corresponding to one respective door for the battery compartment of the plurality of doors for the battery compartment is same as a number of battery modules of the plurality of battery modules corresponding to another door for the battery compartment of the plurality of doors for the battery compartment.

In some embodiments, each two adjacent doors for the battery compartment of the plurality of doors for the battery compartment have a same opening direction or inverse opening directions.

In some embodiments, in the second direction, each two adjacent doors for the battery compartment of the plurality of doors for the battery compartment correspond to and face towards 3 respective battery modules of the plurality of battery modules, and the each two adjacent doors for the battery compartment have inverse opening directions.

In some embodiments, the energy storage system further includes a plurality of high-voltage compartments arranged below the plurality of battery modules in a third direction and electrically connected to the plurality of battery modules. The third direction refers to a height direction of the energy storage system. Each battery module of the plurality of battery modules corresponds to one or two respective high-voltage compartments of the plurality of high-voltage compartments.

In some embodiments, each battery module of the plurality of battery modules corresponds to two respective high-voltage compartments of the plurality of high-voltage compartments and includes a first submodule and a second submodule arranged in the third direction, the first submodule is electrically connected to one high-voltage compartment of the two respective high-voltage compartments, and the second submodule is electrically connected to an other high-voltage compartment of the two respective high-voltage compartments.

In some embodiments, the plurality of doors for the battery compartment are folding doors.

In some embodiments, the battery compartment is configured to accommodate 4 to 8 battery modules arranged at intervals along the first direction, and each battery module includes 6 to 10 battery packs stacked along a third direction, where the third direction refers to a height direction of the energy storage system.

### BRIEF DESCRIPTION OF THE DRAWINGS

One or more embodiments are exemplarily illustrated in reference to corresponding accompanying drawing(s), and these exemplary illustrations do not constitute limitations on the embodiments. The elements having a same reference numeral in the drawings denote the same or similar elements. Unless otherwise stated, the accompanying drawings do not constitute scale limitations. In order to illustrate the technical solutions in related technologies or in the embodiments of the present disclosure more clearly, the drawings to be used in the description of the embodiments will be briefly described below. It is obvious that the drawings mentioned in the following description are only some embodiments of the present disclosure. For those of ordinary skill in the art, other drawings may also be obtained in accordance with these drawings without any inventive effort.

FIG. 1 is a perspective schematic diagram of a local structure of the energy storage system provided in some embodiments of the present disclosure.

FIG. 2 is a perspective schematic diagram of another local structure of the energy storage system provided in some embodiments of the present disclosure.

FIG. 3 is a perspective schematic diagram of a local structure showing the battery modules and liquid cooling pipelines of the energy storage system provided in some embodiments of the present disclosure.

FIG. 4 is a sectional schematic diagram of a structure of a battery module of the energy storage system provided in some embodiments of the present disclosure.

FIG. 5 is a sectional schematic diagram showing a structure of a battery module and a high-voltage compartment of the energy storage system provided in some embodiments of the present disclosure.

FIG. 6 is a sectional schematic diagram showing another structure of a battery module and a high-voltage compartment of the energy storage system provided in some embodiments of the present disclosure.

FIG. 7 is a sectional schematic diagram showing still another structure of a battery module and a high-voltage compartment of the energy storage system provided in some embodiments of the present disclosure.

FIG. 8 is a sectional schematic diagram showing a structure of a high-voltage compartment of the energy storage system provided in some embodiments of the present disclosure.

FIG. 9 is a top schematic diagram showing a structure of battery modules, high-voltage compartments and cable grooves of the energy storage system provided in some embodiments of the present disclosure.

FIG. 10 is a perspective schematic diagram of a local structure of the energy storage system provided in some embodiments of the present disclosure.

FIG. 11 is a perspective schematic diagram of another local structure of the energy storage system provided in some embodiments of the present disclosure.

FIG. 12 is a top schematic diagram showing a structure of the plurality of battery modules of the energy storage system provided in some embodiments of the present disclosure.

FIG. 13 is a top schematic diagram showing another structure of the plurality of battery modules of the energy storage system provided in some embodiments of the present disclosure.

FIG. 14 is a sectional schematic diagram of a structure of a battery module of the energy storage system provided in some embodiments of the present disclosure.

FIG. 15 is a sectional schematic diagram showing a structure of a battery module and a high-voltage compartment of the energy storage system provided in some embodiments of the present disclosure.

FIG. 16 is a sectional schematic diagram showing another structure of a battery module and a high-voltage compartment of the energy storage system provided in some embodiments of the present disclosure.

FIG. 17 is a perspective schematic diagram of a local structure of an electrical compartment of the energy storage system provided in some embodiments of the present disclosure.

FIG. 18 is a top schematic diagram showing a structure of a battery pack of the energy storage system provided in some embodiments of the present disclosure.

FIG. 19 is a top schematic diagram showing another structure of a battery pack of the energy storage system provided in some embodiments of the present disclosure.

FIG. 20 is a top schematic diagram of a first local structure of the energy storage system provided in some embodiments of the present disclosure.

FIG. 21 is a top schematic diagram of a second local structure of the energy storage system provided in some embodiments of the present disclosure.

FIG. 22 is a top schematic diagram of a third local structure of the energy storage system provided in some embodiments of the present disclosure.

FIG. 23 is a top schematic diagram of a fourth local structure of the energy storage system provided in some embodiments of the present disclosure.

### DETAILED DESCRIPTION OF THE EMBODIMENTS

When a certain part “includes” another part throughout the specification, other parts are not excluded unless otherwise stated, and other parts may be further included. In addition, when parts such as a layer, a film, a region, or a plate is referred to as being “on” another part, it may be “directly on” another part or may have another part present therebetween. In addition, when a part of a layer, film, region, plate, etc., is “directly on” another part, it means that no other part is positioned therebetween.

In the drawings, the thickness of layers and an area has been enlarged for better understanding and ease of description. When it is described that a part, such as a layer, film, area, or substrate, is “over” or “on” another part, the part may be “directly” on another part or a third part may be present between the two parts. In contrast, when it is described that a part is “directly on” another part, it means that a third part is not present between the two parts. Furthermore, when it is described that a part is “generally” formed on another part, it means the part is not formed on the entire surface (or front surface) of another part and is also not formed in part of the edge of the entire surface.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise.

It is known from background that the utilization of internal space and the energy density of energy storage systems need to be increased.

After analysis, it was found that in a battery compartment of an energy storage system used to accommodate battery modules, a plurality of battery racks are arranged in an array along a length direction and a width direction of the battery compartment. For example, along the length direction of the battery compartment, a plurality of battery racks are arranged at intervals, and along the width direction of the battery compartment, two battery racks are arranged to space from each other. In this way, a large number of battery modules are arranged in limited layout space of the battery compartment. On the one hand, due to the limitations of the battery compartment, the increase in the volume of the battery modules is limited, which limits the number of battery cells that a battery module can contain, and the increase in the capacity of the battery modules is also limited. On the other hand, due to the spacing between the battery modules, relatively large layout space in the battery compartment is left for the spacing between adjacent battery modules, which also limits the increase in volume of individual battery module. The battery compartment may be an accommodating space in a container, and the width direction of the battery compartment refers to a width direction of the container.

Moreover, when equipment such as fire protection devices, electrical integrated cabinets, and liquid cooling units are arranged separately in the energy storage system, the installation frameworks used to fix and install the fire protection devices, electrical integrated cabinets, and liquid cooling units in the energy storage system are distributed relatively dispersedly, thereby leaving many scattered small spaces that cannot be fully utilized.

Some embodiments of the present disclosure provide an energy storage system. On the one hand, the fire protection devices, electrical integrated cabinets, and liquid cooling units can be arranged compactly, the installation frameworks used to fix and install the fire protection devices, electrical integrated cabinets, and liquid cooling units can be arranged together, and the fire protection devices, electrical integrated cabinets, and liquid cooling units can share a same installation framework, thereby reducing the layout space occupied by at least one of the fire protection devices, electrical integrated cabinets, and liquid cooling units in the energy storage system, and increasing utilization of the layout space in the energy storage system. On the other hand, due to the fact that the layout space occupied by at least one of the fire protection devices, electrical integrated cabinets, and liquid cooling units in the energy storage system is reduced, the volume of the battery compartment can be increased, thereby increasing the total capacity of battery modules that the battery compartment can accommodate. Moreover, the plurality of battery modules are arranged at intervals along the first direction and each of the plurality of battery modules extends along a second direction. In other words, all battery modules are arranged at intervals along only the length direction of the main body, and there is only one battery module being arranged in the width direction of the main body. In this way, the volume of individual battery module can be increased. Firstly, the number of cells that each battery module can contain can be increased, thereby increasing the capacity of each battery module. Secondly, the number of battery modules that need to be arranged in the battery compartment can reduced, thereby reducing the layout space left between adjacent battery modules in the battery compartment, which is conducive to further increase of the total capacity of battery modules that the battery compartment can accommodate, thereby increasing the energy storage density of the energy storage system.

The embodiments of the present disclosure will be described in detail below with reference to the accompanying drawings. Those of ordinary skill in the art shall understand that in the embodiments of the present disclosure, many technical details are provided for readers to better understand the present disclosure, however, even without these technical details and various changes and modifications based on the following embodiments, the technical solutions set forth in the present disclosure can also be realized.

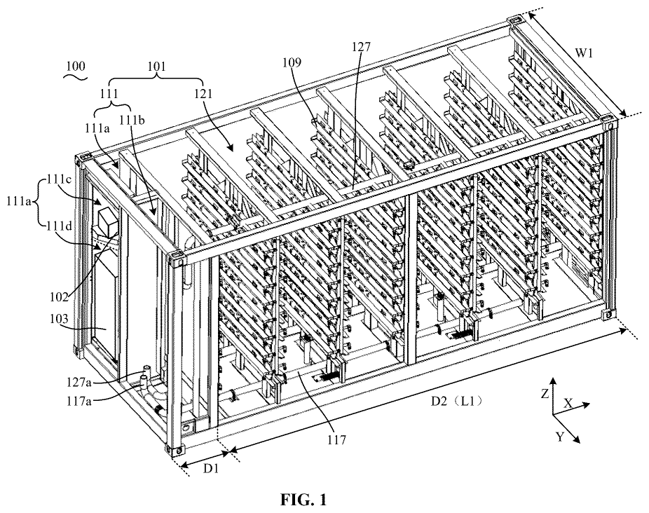

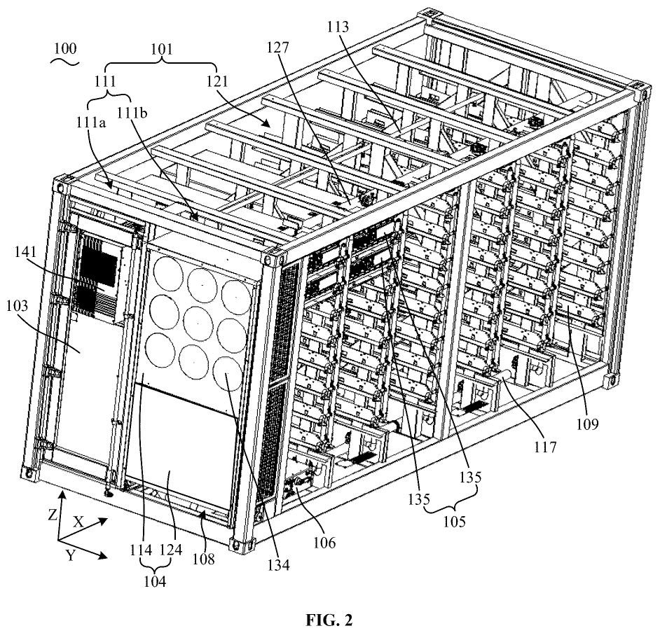

Referring to FIGS. 1 and 2, the energy storage system 100 includes a main body 101 and a plurality of battery modules 105. The main body 101 includes an equipment compartment 111 and a battery compartment 121 arranged in a first direction X. The equipment compartment 111 is configured to accommodate at least one of a fire protection device 102, an electrical integrated cabinet 103, and a liquid cooling unit 104, and the battery compartment 121 is configured to accommodate the plurality of battery modules 105. The plurality of battery modules 105 are arranged in the battery compartment 121. The plurality of battery modules 105 are arranged at intervals along the first direction X and each battery module of the plurality of battery modules 105 extends along a second direction Y. The first direction X refers to a length direction of the energy storage system 100, and the second direction Y refers to a width direction of the energy storage system 100.

FIG. 1 is a perspective schematic diagram of a local structure of the energy storage system provided in some embodiments of the present disclosure, and FIG. 2 is a perspective schematic diagram of another local structure of the energy storage system provided in some embodiments of the present disclosure. It is noted that in FIG. 1, each of the fire protection device 102 and the electrical integrated cabinet 103 is shown as only a simple rectangular prism, respectively. The specific construction and external contour of the fire protection device 102 and the electrical integrated cabinet 103 are not subject to excessive limitations in the embodiments of the present disclosure.

It is noted that the layout space inside the main body 101 is mainly divided into two parts, and there is a significant difference between these two parts. Most of the layout space, namely the battery compartment 121, is used for arrangement of battery modules 105, a small part of the layout space is used as the equipment compartment 111, and the remaining layout space at edges of the main body 101 may be used for layout of cables and pipelines. In this way, the space reserved for the battery compartment 121 in the main body 101 can be ensured to be large enough, and the utilization of the layout space inside the main body 101 can be increased by reserving a small layout space in the main body 101 as the equipment compartment 111 for accommodating at least one of the fire protection device 102, the electrical integrated cabinet 103, and the liquid cooling unit 104.

It is noted that the equipment compartment 111 accommodating at least one of the fire protection device 102, the electrical integrated cabinet 103, and the liquid cooling unit 104 has several layouts as follows.

In some embodiments, there are additional mounting brackets (not shown in the drawings) on the outer side of the main body 101, the equipment compartment 111 is used to accommodate one of the fire protection device 102, the electrical integrated cabinet 103, and the liquid cooling unit 104, and the remaining two are installed in the additional mounting brackets.

In some other embodiments, there is an additional mounting bracket (not shown in the drawings) on the outer side of the main body 101, the equipment compartment 111 is used to accommodate two of the fire protection device 102, the electrical integrated cabinet 103, and the liquid cooling unit 104, and the remaining one is installed in the additional mounting bracket.

In the above embodiments, the equipment compartment 111 needs to accommodate only one or two of the fire protection device 102, the electrical integrated cabinet 103, and the liquid cooling unit 104, with the decrease of the number or volume of the devices need to be accommodate by the equipment compartment 111, the size of the equipment compartment 111 can be further reduced, i.e. the accommodating space of the equipment compartment 111 can be reduced, which is conducive to further increase of the size of the battery compartment 121, i.e. the accommodating space of the battery compartment 121 can be increased. In this way, the total capacity of battery modules 105 that the battery compartment 121 can accommodate can be further increased, thereby increasing the energy storage density of the energy storage system 100.

Moreover, embodiments of the present disclosure do not impose too many restrictions on the relative position relationship between the additional installation bracket(s) and the outer side of the main body 101. In practice, the specific position relationship between the installation bracket(s) and the outer side of the main body 101 can be flexibly adjusted as needed. For example, the installation bracket(s) may be located on the side of the equipment compartment 111 away from the battery compartment 121 along the first direction X, or on the side of the battery compartment 121 away from the equipment compartment 111 along the first direction X.

In some other embodiments, referring to FIGS. 1 and 2, the equipment compartment 111 is used to accommodate the fire protection device 102, the electrical integrated cabinet 103, and the liquid cooling unit 104. The embodiment in which the fire protection device 102, the electrical integrated cabinet 103, and the liquid cooling unit 104 are all arranged in the equipment compartment 111 will be described in detail below. It is noted that in FIGS. 1 and 2, the equipment compartment 111 accommodating only the fire protection device 102, the electrical integrated cabinet 103, and the liquid cooling unit 104 is taken as an example.

In this way, the fire protection device 102, the electrical integrated cabinet 103, and the liquid cooling unit 104 can be arranged compactly, such that all the installation frameworks for installing and fixing the fire protection device 102, the electrical integrated cabinet 103, and the liquid cooling unit 104 can be arranged in the equipment compartment 111, and the fire protection device 102, the electrical integrated cabinet 103, and the liquid cooling unit 104 may share a same installation framework, thereby reducing the layout space occupied by at least one of the fire protection device 102, the electrical integrated cabinet 103, and the liquid cooling unit 104 in the energy storage system 100, and increasing utilization of the layout space in the energy storage system 100.

It is noted that due to the fact that the layout space occupied by at least one of the fire protection device 102, the electrical integrated cabinet 103, and the liquid cooling unit 104 in the energy storage system 100 is reduced, the volume of the battery compartment 121 can be increased, thereby increasing the total capacity of battery modules 105 that the battery compartment 121 can accommodate. Moreover, the plurality of battery modules 105 are arranged at intervals along the first direction X and each of the plurality of battery modules extends along the second direction Y. In other words, all battery modules 105 are arranged at intervals along only the length direction of the main body 101, and there is only one battery module 105 being arranged in the width direction of the main body. In this way, the volume of individual battery module 105 can be increased. Firstly, the number of cells that each battery module 105 can contain can be increased, thereby increasing the capacity of each battery module 105. Secondly, the number of battery modules 105 that need to be arranged in the battery compartment 121 can reduced, thereby reducing the layout space left between adjacent battery modules 105 in the battery compartment 121, which is conducive to further increase of the total capacity of battery modules 105 that the battery compartment 121 can accommodate, thereby increasing the energy storage density of the energy storage system 100.

The following will provide more detailed description of the embodiments of the present disclosure in conjunction with the accompanying drawings.

In some embodiments, referring to FIG. 1, in the first direction X, the equipment compartment 111 has a first size D1, the battery compartment 121 has a second size D2, and a ratio of the first size D1 to the second size D2 ranges from 0.06 to 0.16.

In this way, the battery compartment 121 can be ensured to occupy most of the layout space inside the main body 101. When the ratio of the first size D1 to the second size D2 is greater than 0.16, the space reserved for the battery compartment 121 in the main body 101 is too small, which is not conducive to the increase of the total capacity of battery modules 105 that can be accommodated in the battery compartment 121. When the ratio of the first size D1 to the second size D2 is less than 0.06, the space reserved for the equipment compartment 111 in the main body 101 is too small, which is not conducive to operators installing at least one of the fire protection device 102, the electrical integrated cabinet 103, and the liquid cooling unit 104 into the equipment compartment 111. Thus, the ratio of the first size D1 to the second size D2 is set in the range of 0.06 to 0.16, such that at least one of the fire protection device 102, the electrical integrated cabinet 103, and the liquid cooling unit 104 can be ensured to be accommodated by the equipment compartment 111, and the volume of the battery compartment 121 can be increased as much as possible. In this way, the total capacity of battery modules 105 that the battery compartment 121 can accommodate can be further increased, thereby increasing the energy storage density of the energy storage system 100.

In some embodiments, referring to FIG. 1, the first size D1 ranges from 0.4 m to 0.7 m, and the second size D2 ranges from 4.5 m to 6 m.

In some embodiments, the first size D1 may be 0.44 m, 0.46 m, 0.5 m, 0.55 m, 0.6 m, 0.63 m, 0.65 m, or the like.

In some embodiments, the second size D2 may be 4.6 m, 4.8 m, 5 m, 5.1 m, 5.28 m, 5.5 m, 5.65 m, or the like.

In some embodiments, in the first direction X, the main body 101 has a length ranged from 5.5 m to 6.6 m, such as 5.58 m, 5.69 m, 6.35 m, 6.58 m, or the like. In the second direction Y, the main body 101 has a width ranged from 2.1 m to 2.5 m, such as 2.13 m, 2.25 m, 2.3 m, 2.35 m, 2.4 m, 2.438 m, 2.485 m, or the like. In the third direction Z, the main body 101 has a height ranged from 2.1 m to 3 m, such as 2.18 m, 2.25 m, 2.3 m, 2.4 m, 2.5 m, 2.6 m, 2.7 m, 2.8 m, 2.896 m, 2.973 m, or the like. In some embodiments, the main body 101 may be composed of a 20-foot container.

In some embodiments, the total capacity of all battery modules 105 in the energy storage system ranges from 4 MWh to 6 MWh, such as 4 MWh, 4.53 MWh, 5 MWh, 5.016 MWh, 5.32 MWh, 5.5 MWh, 5.7 MWh, or the like.

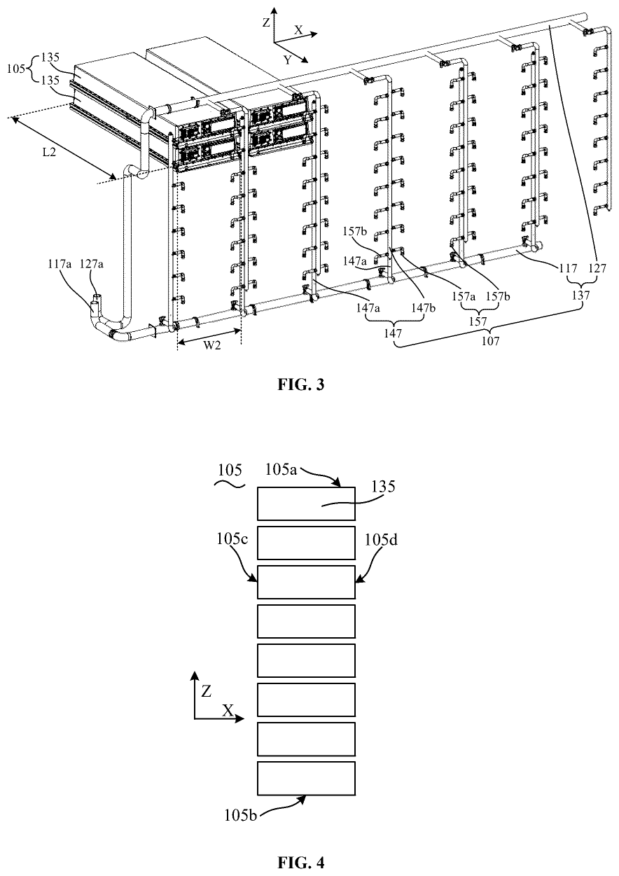

In some embodiments, referring to FIGS. 1 and 3, in the second direction Y, a length L2 of one respective battery module of the plurality of battery modules 105 is less than a width W1 of the battery compartment 121 by 100 mm to 250 mm. In the first direction X, a sum of widths W2 of the plurality of battery modules 105 is less than a length L1 of the battery compartment 121.

In some embodiments, the length L2 of one respective battery module of the plurality of battery modules 105 may be less than the width W1 of the battery compartment 121 by 103 mm, 104 mm 110 mm, 150 mm, 175 mm, 200 mm, 215 mm, 248 mm, or the like.

It is noted that the length of the battery compartment 121 in the first direction X refers to the dimension of the battery compartment 121 in the first direction X, in other words, the first length L1 is the second size D2. FIG. 3 is a perspective schematic diagram of a local structure showing the battery modules and liquid cooling pipelines of the energy storage system provided in some embodiments of the present disclosure.

It is noted that in the second direction Y, the length L2 of one respective battery module of the plurality of battery modules 105 is less than the width W1 of the battery compartment 121, and some other components are arranged on at least one of the two sides of the respective battery module 105 opposite to each other in the second direction Y, for example, liquid cooling pipelines 107 used to dissipate heat from the cells in the battery modules 105. Thus, by designing the length L2 of the respective battery module 105 to be less than the width W1 of the battery compartment 121 by 100 mm to 250 mm, the battery compartment 121 can further contain the liquid cooling pipelines 107, and most of the space in the battery compartment 121 can be used for the layout of the battery modules 105.

It is noted that spaces between adjacent battery modules 105 and used for arranging brackets are necessary. The brackets are configured to install the plurality of battery modules 105 in the battery compartment 121. Therefore, in the first direction X, the sum of widths W2 of the plurality of battery modules 105 is less than the length L1 of the battery compartment 121.

In some embodiments, referring to FIGS. 1 and 3, each battery module 105 has a front surface facing towards the liquid cooling pipelines 107 and a back surface opposite to the front surface in the second direction Y. The energy storage system further includes a sidewall (not shown in the drawings) facing towards the back surface of each battery module 105 in the second direction Y.

In some embodiments, the back surface of each battery module 105 may abut on the sidewall, in other words, the back surface of each battery module 105 may contact with the sidewall in the second direction Y. In some other embodiments, there may be a gap between the back surface of each battery module 105 and the sidewall in the second direction Y, and the gap ranges from 3 mm to 4 mm.

In some embodiments, referring to FIGS. 1 and 3, each battery module 105 has a front surface facing towards the liquid cooling pipelines 107 and a back surface opposite to the front surface in the second direction Y. The battery compartment 121 includes a liquid cooling space for accommodating at least part of the liquid cooling pipelines 107, and the front surface of each battery module 105 faces towards the liquid cooling space.

In some embodiments, a dimension of the liquid cooling space in the second direction Y ranges from 55 mm to 80 mm, for example, 60 mm, 65 mm, 70 mm, 75 mm, or the like.

In some embodiments, referring to FIG. 1, the equipment compartment 111 includes a first compartment 111a and a second compartment 111b arranged along the second direction Y, the first compartment 111a is configured to accommodate the fire protection device 102 and the electrical integrated cabinet 103, and the second compartment 111b is configured to accommodate the liquid cooling unit 104.

It is noted that the first compartment 111a and the second compartment 111b are located on a same side of the battery compartment 121, and the fire protection device 102, the electrical integrated cabinet 103, and the liquid cooling unit 104 may be located on the same side of the battery compartment 121. In this way, the connection and coordination components between the fire protection device 102, the electrical integrated cabinet 103, and the liquid cooling unit 104 and the battery compartment 121 can have a unified connection port, thereby facilitating operators to inspect and maintain the energy storage system 100.

Moreover, the plurality of battery modules 105 are arranged at intervals along the first direction X, and the first compartment 111a and the second compartment 111b are arranged along the second direction Y, so that the fire protection device 102 and the electrical integrated cabinet 103, as a whole, and the liquid cooling unit 104 are arranged along the second direction Y, thereby facilitating the size of the equipment compartment 111 in the second direction Y to be greater than the first size D1 along the first direction X. In other words, the fire protection device 102 and the electrical integrated cabinet 103, as a whole, and the liquid cooling unit 104 are arranged along the second direction Y, such that the equipment compartment 111 can accommodate the fire protection device 102, the electrical integrated cabinet 103, and the liquid cooling unit 104, while can have a first size D1 as small as possible along the first direction X. In this way, the second size D2 of the battery compartment 121 in the first direction X can be increased, so that the battery compartment 121 can accommodate more battery modules 105.

In some embodiments, referring to FIG. 1, the fire protection device 102 and the electrical integrated cabinet 103 are arranged along a third direction Z and spaced from each other, the third direction Z refers to the height direction of the energy storage system 100. In some embodiments, referring to FIG. 1, the first compartment 111a may further include an upper compartment 111c and a lower compartment 111d arranged along the third direction Z. Referring to FIGS. 1 and 2, a cooling device 141 is installed in the upper compartment 111c, and the lower compartment 111d is used to accommodate the electrical integrated cabinet 103.

In this way, the cold air in the upper compartment 111c that has been cooled by the cooling device 141 flows downwards to the lower compartment 111d, and then can enter the electrical integrated cabinet 103 to cool down the interior of the electrical integrated cabinet 103. The hot air inside the electrical integrated cabinet 103 can enter the lower compartment 111d, and further flow upwards to the upper compartment 111c to be cooled down using the cooling device 141. In this way, a circulating exchange of cold and hot air flow can be achieved, thereby further improving the overall heat dissipation effect of the electrical integrated cabinet 103.

In some embodiments, the cooling device 141 may be an air conditioner, and the cooling device 141 may be installed on a door adapted to the equipment compartment 111.

It is noted that in FIG. 1, the upper compartment 111c and the lower compartment 111d are roughly divided by dashed lines.

In some embodiments, referring to FIGS. 1 and 2, the upper compartment 111c further accommodates a fire protection pipeline 113 that extends from the battery compartment 121. The inlet of the fire protection pipeline 113 is connected to the fire protection device 102, and the outlet of the fire protection pipeline 113 is located in the battery compartment 121. The part of the fire protection pipeline 113 located in the battery compartment 121 extends along the first direction X and is located on the top surfaces of the battery modules 105 in the third direction Z.

It should be noted that the part of the fire protection pipeline 113 located in the battery compartment 121 may have a plurality of outlets for targeted fire protection treatment of different sections in the battery compartment 121. The number of the outlets of the fire protection pipeline 113 may be flexibly designed according to actual needs.

In some embodiments, referring to FIG. 2, the liquid cooling unit 104 includes a first portion 114 and a second portion 124 arranged along the third direction Z, and the first portion 114 includes a plurality of air exhaust devices 134. Referring to FIGS. 1 and 2, the second portion 124 is connected with the inlet 117a of the main inflow pipeline 117 and the outlet 127a of the main outflow pipeline 127.

It should be noted that FIG. 2 only exemplarily illustrates the approximate positions of the air exhaust devices 134 in the first portion 114 using circular shapes, embodiments of the present disclosure do not limit the specific construction of the air exhaust devices 134.

In some embodiments, the air exhaust devices 134 may be exhaust fans. In some embodiments, referring to FIG. 2, 9 exhaust fans are arranged on the first portion 114 and are arranged in a 3*3 array along the second direction Y and the third direction Z.

It should be noted that the brackets used to install and fix the air exhaust devices 134 and the air exhaust devices 134, as a whole, may serve as a wallboard of the first portion 114, and the housing of the second portion 124 may also serve as wallboards. Therefore, the second compartment 111b that accommodates the liquid cooling unit 104 does not need additional wallboards, which is beneficial for reducing the cost of the energy storage system.

In some embodiments, referring to FIG. 2, the second portion 124 has a sidewall extending perpendicular to the first direction X, there is a gap 108 between the sidewall and a bottom of the main body 101 in the third direction Z, and the gap 108 is formed on a side of the main body 101 perpendicular to the first direction X. The energy storage system 100 further includes a decorative panel (not shown in the drawings) configured to block the gap 108. In this way, the decorative panel can be used to shield the bottom area of the second compartment 111b (refer to FIG. 1) in the third direction Z, thereby preventing debris and small animals from entering the main body 101, and preventing small animals from causing damage to various components arranged inside the main body 101. In other words, it is conducive to improvement of the overall sealing and service life of the energy storage system.

In some embodiments, referring to FIGS. 2 and 3, each of the plurality of battery modules 105 includes a plurality of battery packs 135 stacked along a third direction Z, and the third direction Z refers to a height direction of the energy storage system 100.

In some embodiments, the battery compartment 121 accommodates 4-8 battery modules 105 arranged at intervals along the first direction X, and each battery module 105 includes 6-10 battery packs 135 stacked along a third direction, where the third direction Z refers to a height direction of the energy storage system 100.

In some embodiments, referring to FIGS. 1 to 3, the battery compartment 121 accommodates 6 battery modules 105 arranged at intervals along the first direction X, and referring to FIGS. 1 to 6, each battery module 105 includes 8 battery packs 135 stacked along the third direction.

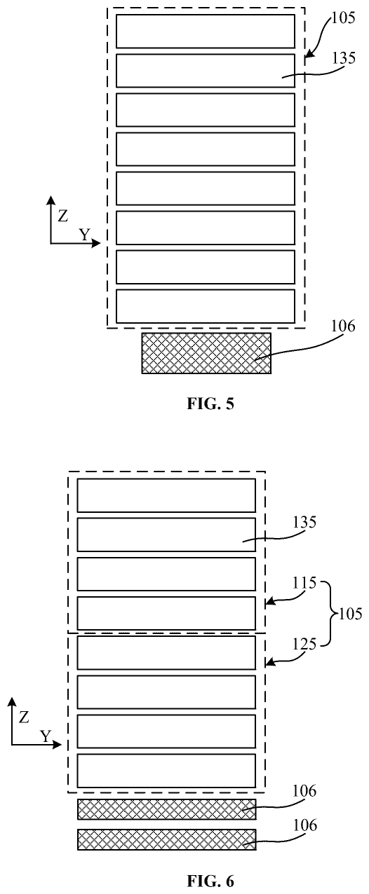

It is noted that in FIGS. 2 and 3, only 2 battery modules 105 spaced from each other along the first direction X and only 2 battery packs 135 of each battery module 105 are illustrated. Moreover, FIG. 4 is a sectional schematic diagram of a structure of a battery module of the energy storage system provided in some embodiments of the present disclosure, FIG. 5 is a sectional schematic diagram showing a structure of a battery module and a high-voltage compartment of the energy storage system provided in some embodiments of the present disclosure, and FIG. 6 is a sectional schematic diagram showing another structure of a battery module and a high-voltage compartment of the energy storage system provided in some embodiments of the present disclosure. It is noted that in order to clearly illustrate the layout of the plurality of battery packs 135 of each battery module 105, as well as the positional relationship between the battery module 105 and the high-voltage compartment 106, FIGS. 4 to 6 show simple drawings of a battery module 105, and FIGS. 5 and 6 show simple drawings of the high-voltage compartment 106.

Moreover, in FIGS. 1 to 3, the battery compartment 121 accommodating only 6 battery modules 105 arranged at intervals along the first direction X is taken as an example, and embodiments of the present disclosure do not limit the number of the battery modules 105 arranged at intervals along the first direction X in the battery compartment 121, as long as these battery modules 105 can be arranged in the battery compartment 121. In FIGS. 1 to 6, the battery module 105 including only 8 battery packs 135 stacked along the third direction is taken as an example, in practice, the number of battery packs 135 contained in each battery module 105 may be flexibly adjusted based on the layout space for each battery module 105.

In some embodiments, referring to FIGS. 1 and 2, the energy storage system 100 may further include a plurality of brackets 109 configured to carry battery packs 135 of the plurality of battery modules 105 and extending in the second direction Y. Each battery pack 135 of the battery packs is arranged on two respective brackets of the plurality of brackets 109 spaced from each other in the first direction X.

It is noted that the embodiments of the present disclosure do not limit the specific form of the brackets 109 used to carry the battery packs 135, as long as the battery packs 135 can be installed in the battery compartment 121 with the aid of the brackets 109.

In some embodiments, referring to FIGS. 2, 5 and 6, the energy storage system 100 may further include a plurality of high-voltage compartments 106 arranged below the plurality of battery modules 105 in a third direction Z and electrically connected to the plurality of battery modules 105, where the third direction Z refers to a height direction of the energy storage system 100. Each battery module of the plurality of battery modules 105 corresponds to one or two respective high-voltage compartments 106 of the plurality of high-voltage compartments 106.

In some embodiments, referring to FIG. 5, each battery module 105 corresponds to one respective high-voltage compartment of the plurality of high-voltage compartments 106. In some other embodiments, referring to FIG. 6, each battery module 105 corresponds to two respective high-voltage compartments of the plurality of high-voltage compartments 106.

It is noted, referring to FIG. 6, that each battery module 105 includes a plurality of battery packs 135 stacked along the third direction. When each battery module 105 includes a relatively large number of battery packs 135, considering that each high-voltage compartment 106 has respective rated power parameters, each battery module 105 may be designed to correspond to two respective high-voltage compartments 106, in order to prevent the inability of a high-voltage compartment 106 to function properly, when a battery module 105 is electrically connected to only this high-voltage compartment 106, due to an excessive number of battery packs 135 contained in the battery module 105.

In some embodiments, referring to FIG. 5, when each battery module 105 corresponds to one respective high-voltage compartment 106 and a plane perpendicular to the third direction Z is used as a projection plane, an orthographic projection of the respective high-voltage compartment 106 on the projection plane overlaps with an orthographic projection of the each battery module 105 on the projection plane. In some embodiments, the orthographic projection of the respective high-voltage compartment 106 on the projection plane may be centered on the orthographic projection of the each battery module 105 on the projection plane.

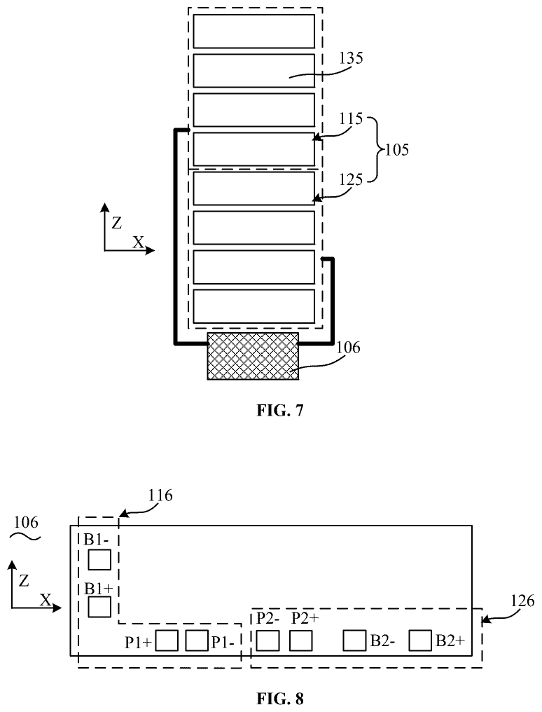

In some embodiments, referring to FIGS. 7 and 8, when each battery module of the plurality of battery modules 105 corresponds to one respective high-voltage compartment of the plurality of high-voltage compartments 106, each battery module 105 includes a first submodule 115 and a second submodule 125 arranged along the third direction. The one respective high-voltage compartment 106 has a first input and output port 116 and a second input and output port 126 arranged on a side of the one respective high-voltage compartment 106 extending perpendicular to the second direction Y, and the first input and output port 116 and the second input and output port 126 are spaced from each other. The one respective high-voltage compartment 106 further includes a first high-voltage device (not shown in the drawings) and a second high-voltage device (not shown in the drawings). The first high-voltage device corresponds to the first input and output port 116, and the second high-voltage device corresponds to the second input and output port 126.

In some embodiments, referring to FIG. 8, the first input and output port 116 includes: a DC high-voltage output port B1+ of the first high-voltage device, a DC low-voltage output port B1− of the first high-voltage device, an AC high-voltage input port P1+ of the first high-voltage device, and an AC low-voltage input port P1− of the first high-voltage device. The second input and output port 126 includes: a DC high-voltage output port B2+ of the second high-voltage device, a DC low-voltage output port B2− of the second high-voltage device, an AC high-voltage input port P2+ of the second high-voltage device, and an AC low-voltage input port P2− of the second high-voltage device. In other words, each high-voltage compartment 106 is a dual in and dual out high-voltage electronic device.

In some embodiments, referring to FIGS. 7 and 8, the first input and output port 116 corresponding to the first high-voltage device is electrically connected to the first submodule 115, and the second input and output port 126 corresponding to the second high-voltage device is electrically connected to the second submodule 125. In this way, the ports of each high-voltage compartment 106 that are electrically connected to a respective battery module 105 are located on a side of the high-voltage compartment 106 close to the liquid cooling pipelines in the second direction Y, and the doors of the energy storage system are also located on the side of the each high-voltage compartment 106 and the respective battery module 105 close to the liquid cooling pipelines in the second direction Y, thereby allowing operators to open the door to connect, inspect, and repair the ports of the high-voltage compartment 106, and improving the convenience for the operators.

In some embodiments, the high-voltage compartment 106 has a rated voltage of 1500V, and each of the first high-voltage device and the second high-voltage device has the rated voltage of 1500V.

FIG. 7 is a sectional schematic diagram showing still another structure of a battery module and a high-voltage compartment of the energy storage system provided in some embodiments of the present disclosure, and FIG. 8 is a sectional schematic diagram showing a structure of a high-voltage compartment of the energy storage system provided in some embodiments of the present disclosure. It is noted that FIG. 7 only exemplarily illustrates the approximate wiring arrangement between the first input and output port 116 and the first submodule 115, as well as the approximate wiring arrangement between the second input and output port 126 and the second submodule 125. Embodiments of the present disclosure do not limit the specific wiring arrangement between the high-voltage compartments 106 and the battery modules 105. In addition, in FIG. 8, the first input and output port 116 and the second input and output port 126 are represented by dashed boxes. FIG. 8 only shows one layout for the first input and output port 116 and the second input and output port 126. Embodiments of the present disclosure do not impose too many restrictions on the layouts of the first input and output port 116 and the second input and output port 126.

In some other embodiments, referring to FIG. 6, each battery module of the plurality of battery modules 105 corresponds to two respective high-voltage compartments of the plurality of high-voltage compartments 106 and includes a first submodule 115 and a second submodule 125 arranged in the third direction Z. The first submodule 115 is electrically connected to one high-voltage compartment 106 of the two respective high-voltage compartments, and the second submodule 125 is electrically connected to an other high-voltage compartment 106 of the two respective high-voltage compartments.

It is noted that each of the first submodule 115 and the second submodule 125 includes a plurality of battery packs 135. Embodiments of the present disclosure do not limit the number of battery packs 135 of the first submodule 115 and the number of battery packs 135 of the second submodule 125.

In some embodiments, each battery module 105 includes 8 battery packs 135 stacked along the third direction. In the third direction, these 8 battery packs 135 include 4 upper long packs and 4 lower long packs. The first submodule 115 includes the 4 upper long packs, and the second submodule 125 includes the 4 lower long packs.

The two respective high-voltage compartments 106 may be arranged in the following ways: referring FIG. 4, the two respective high-voltage compartments 106 may be stacked along the third direction Z, or may be arranged to space from each other along the second direction, or may be arranged to space from each other along the first direction. It is noted that when a plane perpendicular to the third direction Z is used as a projection plane, the orthographic projections of the two respective high-voltage compartments 106 on the projection plane may both be located in the orthographic projection of the each battery module 105 on the projection plane.

In some embodiments, referring to FIGS. 1 and 3, the energy storage system further includes liquid cooling pipelines 107 arranged on a side of the battery compartment 121 extending perpendicular to the second direction Y.

It is noted that all battery modules 105 are arranged at intervals along the first direction X, and there is only one battery module 105 being arranged in the width direction of the main body. In this way, the liquid cooling pipelines 107 only need to be arranged on one of the two sides of the battery compartment 121 opposite to each other along the second direction Y, so that the liquid cooling pipelines 107 can pass each battery module 105 along the first direction X. In this way, the number of battery modules 105 to be arranged in the battery compartment 121 can be reduced, dissipation of heat from the battery modules 105 by the liquid cooling pipelines 107 can be ensured, and the total length of the liquid cooling pipelines 107 can be reduced, thereby reducing the layout space required for the liquid cooling pipelines 107 in the battery compartment 121.

In some embodiments, referring to FIGS. 3 and 4, in a third direction Z, each battery module of the plurality of battery modules 105 has a bottom side 105a and a top side 105b, where the third direction Z refers to a height direction of the energy storage system 100. The liquid cooling pipelines 107 include a main inflow pipeline 117 and a main outflow pipeline 127, and in the third direction Z, one of the main inflow pipeline 117 and the main outflow pipeline 127 is arranged on the bottom side 105a and has a part facing towards the bottom side 105a, and an other of the main inflow pipeline 117 and the main outflow pipeline 127 is arranged on the top side 105b and has a part facing towards the top side 105b. The main inflow pipeline 117 has an inlet 117a, the main outflow pipeline 127 has an outlet 127a, and the inlet 117a and the outlet 127a are connected to the liquid cooling unit 104 (referring to FIG. 2).

It is noted that FIG. 3 exemplarily shows that the main inflow pipeline 117 is arranged on the bottom side 105a of the each battery module 105 (referring to FIG. 4), and the main outflow pipeline 127 is arranged on the top side 105b of the each battery module 105 (referring to FIG. 4). In practice, the main inflow pipeline may be arranged on the top side, and the main outflow pipeline may be arranged on the bottom side.

In the following, dissipation of heat from the battery modules 105 by the liquid cooling pipelines 107 is described in detail, taking the main inflow pipeline 117 being arranged on the bottom side 105a of the each battery module 105 and the main outflow pipeline 127 being arranged on the top side 105b of the each battery module 105 as an example. In this way, the cooling medium that has undergone cooling treatment in the liquid cooling unit 104 flows into the battery compartment 121 from the inlet 117a of the main inflow pipeline 117, then the cooling medium in the main inflow pipeline 117 flows upwards along the third direction Z from the bottom of the battery compartment 121, i.e. the bottom side 105a, to enter each battery module 105. After dissipating heat from each battery module 105, the cooling medium discharged from each battery module 105 flows upwards along the third direction Z to converge into the main outflow pipeline 127. The cooling medium in the main outflow pipeline 127 flows from the top of the battery compartment 121, i.e. the top side 105b, into the outlet 127a of the main outflow pipeline 127, and then flows into the liquid cooling unit 104, waiting for further cooling treatment.

It is noted that the main inflow pipeline 117 and the main outflow pipeline 127 are arranged on two sides of the plurality of battery modules 105 opposite to each other in the third direction Z, respectively, and the cooling medium successively flows through the main inflow pipeline 117, each battery module 105, and the main outflow pipeline 127 along the third direction Z. In other words, the main flow path of the cooling medium in the liquid cooling pipelines 107 located in the battery compartment 121 is upward along the third direction Z, and will not flow back down along the third direction Z, which is conducive to reduction of the length of the main flow path of the cooling medium in the liquid cooling pipelines 107 located in the battery compartment 121, thereby further reducing the layout space required for the liquid cooling pipelines 107 in the battery compartment 121.

In some embodiments, referring to FIG. 3, the liquid cooling pipelines 107 includes: first-level pipelines 137, second-level pipelines 147, and third-level pipelines 157. The main inflow pipeline 117 and the main outflow pipeline 127 belong to the first-level pipelines 137. The main inflow pipeline 117 and the main outflow pipeline 127 located in the battery compartment 121 extend along the first direction X. The second-level pipelines 147 and the third-level pipelines 157 are located in the battery compartment 121. The second-level pipelines 147 extend along the third direction Z, and one end of each second-level pipeline 147 is communicated with the main inflow pipeline 117 or the main outflow pipeline 127. One end of each third-level pipeline 157 is communicated with a respective second-level pipeline 147, and the other end of the each third-level pipeline 157 is communicated with a cooling chamber in a respective battery pack 135.

In some embodiments, referring to FIGS. 3 and 4, each battery module 105 has a third side 105c and a fourth side 105d opposite to each other along the first direction X. Each second-level pipeline 147 is a second-level inflow pipeline 147a or a second-level outflow pipeline 147b, and each battery module 105 corresponds to a second-level inflow pipeline 147a and a second-level outflow pipeline 147b. In some embodiments, the second inflow pipeline 147a is located on the third side 105c of a corresponding battery module 105, and the second outflow pipeline 147b is located on the fourth side 105d of the corresponding battery module 105. Compared to the fourth side 105d, the third side 105c is closer to the inlet 117a of the main inflow pipeline 117 in the first direction X.

In some embodiments, referring to FIG. 3, each second-level inflow pipeline 147a has two ends opposite to each other in the third direction Z, one end is communicated with the main inflow pipeline 117, and the other end is sealed. Each second-level outflow pipeline 147b has two ends opposite to each other in the third direction Z, one end is communicated with the main outflow pipeline 127, and the other end is sealed.

In some embodiments, referring to FIGS. 3 and 4, each battery module 105 has a third side 105c and a fourth side 105d opposite to each other along the first direction X. Each third-level pipeline 157 is a third-level inflow pipeline 157a or a third-level outflow pipeline 157b. Each battery module 105 includes a plurality of battery packs 135 stacked along the third direction Z, each battery pack 135 corresponds to a three-level inflow pipeline 157a and a three-level outflow pipeline 157b, and each battery module 105 corresponds to several three-level inflow pipelines 157a and several three-level outflow pipelines 157b.

Each second-level inflow pipeline 147a is communicated with several three-level inflow pipelines 157a, and the three-level inflow pipelines 157a corresponding to a same battery module 105 are arranged at intervals along the third direction Z. Each second-level outflow pipeline 147b is communicated with several three-level outflow pipelines 157b, and the three-level outflow pipelines 157b corresponding to a same battery module 105 are arranged at intervals along the third direction Z.

Each battery pack 135 has an inlet (not denoted in the drawings) and an outlet (not denoted in the drawings) arranged opposite to each other along the first direction X. Both the inlet and outlet are communicated with the cooling chamber, the inlet is communicated with the third-level inflow pipeline 157a, and the outlet is communicated with the third-level outflow pipeline 157b.

In some embodiments, each of the plurality of battery modules 105 arranged at intervals along the first direction X has an area facing towards the main inflow pipeline 117 in the third direction Z, in order to ensure that the cooling medium in the main inflow pipeline 117 can flow to each battery pack 135 via the third-level pipelines 157 and the second-level pipelines 147, thereby achieving heat dissipation of each battery pack 135. Similarly, each of the plurality of battery modules 105 arranged at intervals along the first direction X has an area facing towards the main outflow pipeline 127 in the third direction Z, in order to ensure that the cooling medium discharged from each battery pack 135 can converge to the main outflow pipeline 127 via the third-level pipelines 157 and the second-level pipelines 147.

In some embodiments, the cooling chamber in each battery pack 135 may be a liquid cooling plate.

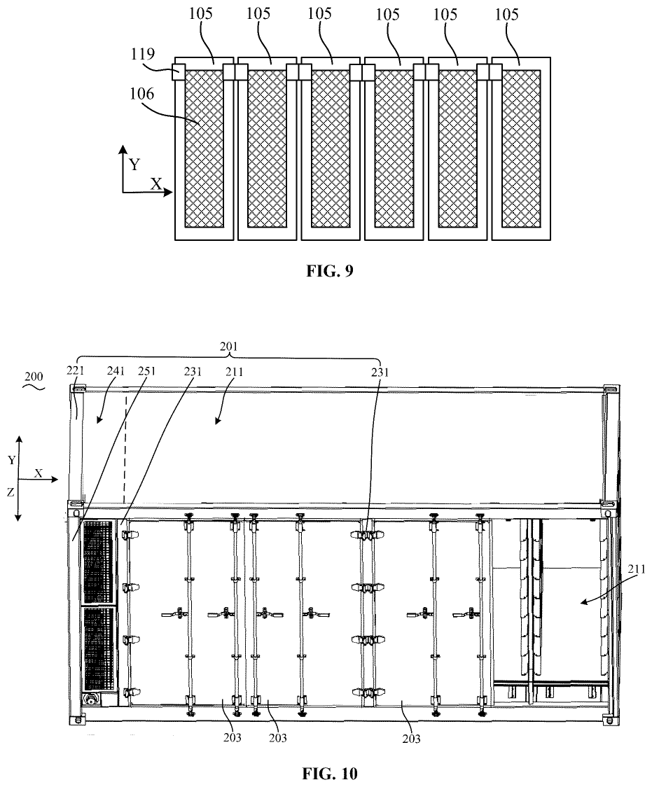

In some embodiments, referring to FIG. 9, FIG. 9 is a top schematic diagram showing a structure of battery modules, high-voltage compartments and cable grooves of the energy storage system provided in some embodiments of the present disclosure. A plurality of cable grooves 119 are defined in the main body 101 and include bottom cable grooves that are defined at a bottom of the battery compartment 121 in a third direction, and the third direction refers to a height direction of the energy storage system. In this way, the regularity of the wiring in the energy storage system can be improved by using the cable grooves 119 defined at the bottom of the battery compartment 121 in the third direction Z, and can fully utilize the layout space inside the main body 101, thereby further increasing the space utilization of the main body 101.

In some embodiments, the plurality of cable grooves 119 may be flame-retardant cable grooves, such as fire-resistant PVC cable grooves.

In some embodiments, parts of the cable grooves 119 may be located in the spacing between adjacent high-voltage compartments 106 in the second direction Y, respectively. In this way, the space at the bottom of the battery compartment in the main body 101 can be further fully utilized, thereby further increasing the space utilization of the main body 101.

In some embodiments, referring to FIGS. 1 and 9, the bottom cable grooves include first cable grooves (not shown in the drawings) and second cable grooves (not shown in the drawings), and the first cable grooves are independent of the second cable grooves. The energy storage system may further include: first cables (not shown in the drawings) arranged in the first cable grooves, where the first cables are used to conduct dynamic electricity; and second cables (not shown in the drawings) arranged in the second cable grooves, where the second cables are used to transmit signals.

It is noted that the first cable grooves being independent of the second cable grooves refers to that the first cable grooves are spaced from and insulated from the second cable grooves, in other words, the cables used to conduct dynamic electricity are arranged to be independent of the cables used to transmit signals, which is conducive to reduction of the electrical interference between the dynamic electricity cables and the signal cables.

In some embodiments, the cables electrically connected to the first input and output port 116 and the second input and output port 126 of each high-voltage compartment 106 are the first cables, i.e. the cables used to conduct dynamic electricity. Moreover, each high-voltage compartment 106 further has several programmable input ports, several passive programmable relay output ports, and other communication ports. The second cables are electrically connected to communication ports.

In some embodiments, the cable grooves 119 are fire-resistant PVC cable grooves, which is conducive to further improving the anti-interference and electromagnetic shielding effects of the cable grooves 119 with the aid of the insulation performance of fire-resistant PVC cable grooves, in order to further reduce the electrical interference between the dynamic electricity cables and the signal cables.

In some embodiments, the first cables and the second cables are all made of flame-retardant materials.

In summary, on the one hand, the fire protection device 102, the electrical integrated cabinet 103, and the liquid cooling unit 104 are arranged compactly, the size of the equipment compartment 111 can be reduced, which is conducive to further increase of the size of the battery compartment 121, i.e. the accommodating space of the battery compartment 121 can be increased. In this way, the total capacity of battery modules 105 that the battery compartment 121 can accommodate can be further increased, thereby increasing the energy storage density of the energy storage system 100, and increasing utilization of the layout space in the energy storage system. On the other hand, all battery modules 105 are arranged at intervals along only the length direction of the main body 101, and there is only one battery module 105 being arranged in the width direction of the main body. In this way, the volume of individual battery module 105 can be increased. Firstly, the number of cells that each battery module 105 can contain can be increased, thereby increasing the capacity of each battery module 105. Secondly, the number of battery modules 105 that need to be arranged in the battery compartment 121 can reduced, thereby reducing the layout space left between adjacent battery modules 105 in the battery compartment 121, which is conducive to further increase of the total capacity of battery modules 105 that the battery compartment 121 can accommodate, thereby increasing the energy storage density of the energy storage system 100.

It is known from background that the coordination relationships between battery modules and doors for a battery compartment, and between doors for the battery compartment and a main body of a container needs to be improved.

After analysis, it was found that battery modules in an energy storage system are usually arranged as follows: in a battery compartment used to accommodate battery modules, a plurality of battery racks are arranged in an array along a length direction and a width direction of the battery compartment. For example, along the length direction of the battery compartment, a plurality of battery racks are arranged at intervals, and along the width direction of the battery compartment, two battery racks are arranged to space from each other. In other words, as for a battery rack, there is another battery rack arranged along the same direction in either the length direction of the battery compartment or the width direction of the battery compartment. The battery compartment may be a storage space in the container, and the width direction of the battery compartment is a width direction of the container.

Therefore, when installing the battery racks into the battery compartment, it is necessary to design the container to have double-sided doors in the width direction of the container to facilitate the installation of all battery racks into the container. Based on this, for any container, a certain amount of space needs to be reserved on both sides of the container in the width direction, so that the doors for the battery compartment on both sides can be opened for installation, inspection, or maintenance of the battery racks or other components. Therefore, for any container, some certain spaces need to be reserved on both sides in its width direction to open the doors for the battery compartment, which is not conducive to the high-density arrangement of a plurality of containers.

Moreover, the hinge joint between each door for the battery compartment and the main body of the container will also occupy the layout space in the main body. The more doors for the battery compartment are arranged, the less space is reserved for the installation of battery racks in the container.

Some embodiments of the present disclosure provide an energy storage system. On the one hand, a plurality of battery modules in a battery compartment are arranged at intervals along a same direction, i.e. a first direction or a second direction. In this way, it is conducive to flexible adjustment of the number of battery modules arranged at intervals along the first direction or the second direction based on the space used for arranging the battery modules in the battery compartment, in order to increase the integration density of the battery modules in the battery compartment. Moreover, a plurality of battery modules located in the battery compartment are arranged at intervals along a same direction. In other words, the arrangement of all battery modules has only one arrangement direction, i.e. the first direction or the second direction. Based on this, each door for the battery compartment of the plurality of doors for the battery compartment is arranged on one respective side of two sides of the battery modules opposite to each other along the second direction, and in the second direction, each door for the battery compartment corresponds to and faces towards at least one respective battery module of the plurality of battery modules, and at least some of the doors for the battery compartment will not directly face to each other along the second direction, which is conducive to reduction of the number of the doors for the battery compartment. On the other hand, each door for the battery compartment is hinged to the main body, and the hinge joint between each door for the battery compartment and the main body will also occupy the layout space in the main body. Therefore, reduction of the number of the doors for the battery compartment to be arranged is beneficial for reducing the reserved space in the main body for hinge connection of the doors for the battery compartment, thereby increasing the space used for installing battery modules in the main body, and further increasing the integration density of battery modules.

The embodiments of the present disclosure will be described in detail below with reference to the accompanying drawings. Those of ordinary skill in the art shall understand that in the embodiments of the present disclosure, many technical details are provided for readers to better understand the present disclosure, however, even without these technical details and various changes and modifications based on the following embodiments, the technical solutions set forth in the present disclosure can also be realized.

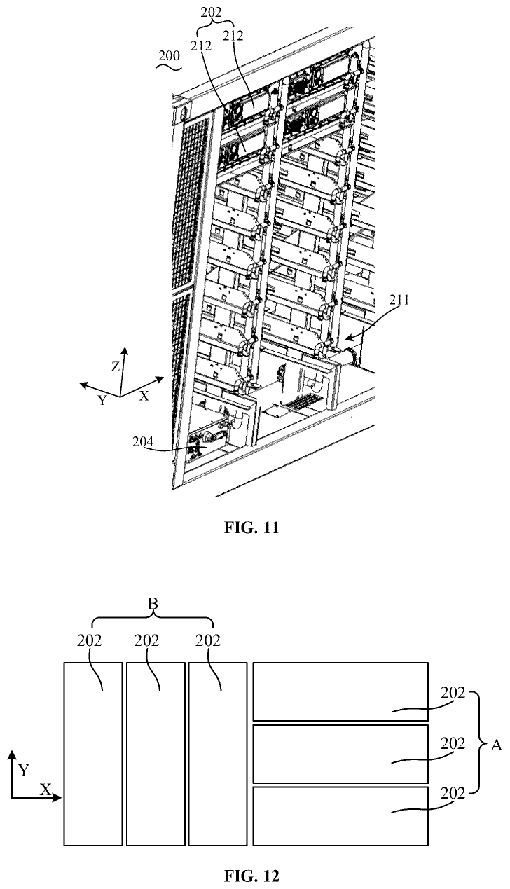

Referring to FIGS. 10 and 11, the energy storage system 200 includes a main body 201 including a battery compartment 211 configured to accommodate a plurality of battery modules 202, the plurality of battery modules 202 arranged in the battery compartment 211, and a plurality of doors 203 for the battery compartment. The plurality of battery modules 202 are arranged at intervals along a first direction X or a second direction Y, where the first direction X refers to a length direction of the energy storage system 200, and the second direction Y refers to a width direction of the energy storage system 200. Each door 203 for the battery compartment of the plurality of doors 203 for the battery compartment is arranged on one respective side of two sides of the main body perpendicular to the second direction Y, and is hinged to the main body 201. In the second direction, each door 203 for the battery compartment of the plurality of doors 203 for the battery compartment corresponds to and faces towards at least one respective battery module 202 of the plurality of battery modules 202.

FIG. 10 is a perspective schematic diagram of a local structure of the energy storage system provided in some embodiments of the present disclosure. FIG. 11 is a perspective schematic diagram of another local structure of the energy storage system provided in some embodiments of the present disclosure. It is noted that in order to illustrate the battery compartment 211, only a portion of the plurality of doors 203 for the battery compartment in the energy storage system 200 are shown in FIG. 10, and the plurality of battery modules 202 are not shown in FIG. 10. The plurality of doors 203 for the battery compartment are not shown in FIG. 11.

It is noted that the plurality of battery modules 202 in the battery compartment 211 are arranged at intervals along a same direction, i.e. the first direction or the second direction. In this way, it is conducive to flexible adjustment of the number of battery modules 202 arranged at intervals along the first direction or the second direction based on the space used for arranging the plurality of battery modules 202 in the battery compartment 211, in order to increase the integration density of the plurality of battery modules 202 in the battery compartment 211.

The plurality of battery modules 202 may be arranged at intervals along the first direction X or the second direction Y in the following at least two manners.

In some embodiments, referring to FIG. 12, FIG. 12 is a top schematic diagram showing a structure of the plurality of battery modules of the energy storage system provided in some embodiments of the present disclosure. The plurality of battery modules 202 includes a first module group A and a second module group B. A plurality of battery modules 202 of the first module group A are arranged at intervals along the first direction X, and a plurality of battery modules 202 of the second module group B are arranged at intervals along the second direction Y.

It is noted that each battery module 202 is implemented as a battery rack including a plurality of battery packs electrically connected in series or in parallel. The first module group A includes a plurality of battery modules 202 arranged along a first arrangement direction, and the second module group B also includes a plurality of battery modules 202 arranged along a second arrangement direction different from the first arrangement direction. Each battery module 202 belongs to either the first module group A or the second module group B. In other words, as for several battery modules 202 arranged along the first direction X, each of these battery modules 202 would not be arranged in the second direction Y together with any other battery module 202, vice versa.

In FIG. 12, a first module group A including 3 battery modules 202 arranged at intervals along the first direction X and a second module group B including 3 battery modules 202 arranged at intervals along the second direction Y are taken as an example, embodiments of the present disclosure do not limit the number of battery modules of the first module group A and the number of battery modules of the second module group B, as long as the plurality of battery modules 202 can be arranged in the battery compartment 211. In other words, the number of battery modules 202 of the first module group A and the number of battery modules 202 of the second module group B can be adjusted flexibly based on the space for arranging the plurality of battery modules 202 in the battery compartment 211, in order to increase the integration density of the plurality of battery modules 202 in the battery compartment 211.

Moreover, the battery modules 202 of the first module group A have a same first dimension, the battery modules 202 of the second module group B have a same second dimension, and the first dimension may be the same as or different from the second dimension. The first dimension and the second dimension may be adjusted flexibly based on the space for arranging the plurality of battery modules 202 in the battery compartment 211.

It is noted that the plurality of battery modules 202 in the battery compartment 211 are arranged at intervals along a same direction, based on this, each door for the battery compartment of the plurality of doors for the battery compartment 203 is arranged on one respective side of two sides of the main body perpendicular to the second direction Y, and in the second direction Y, each door for the battery compartment of the plurality of doors 203 for the battery compartment corresponds to and faces towards at least one respective battery module of the plurality of battery modules 202. In this way, at least some of the plurality of doors 203 for the battery compartment do not directly face each other in the second direction Y. For example, in the second direction, the doors 203 for the battery compartment corresponding to and facing towards the battery modules of the first module group A do not directly face each other.

Regarding the plurality of doors 203 for the battery compartment, in some embodiments, in the second direction Y, each door 203 for the battery compartment corresponds to and faces towards a same number of respective battery modules of the plurality of battery modules 202, for example 1, 1.5, or 2 respective battery modules of the plurality of battery modules 202. In some other embodiments, one of the plurality of doors 203 for the battery compartment corresponds to and faces towards a first number of battery modules of the plurality of battery modules 202, another of the plurality of doors 203 for the battery compartment corresponds to and faces towards a second number of battery modules of the plurality of battery modules 202, and the first number is different from the second number. In some still other embodiments, some of the plurality of battery modules 202, for example the battery modules 202 in the middle of the second module group B, have no doors 203 for the battery compartment corresponding to and facing towards them in the second direction Y. In the following, the corresponding relationships between the plurality of doors 203 for the battery compartment and the plurality of battery modules 202 in the energy storage system will be described in detail.

Therefore, based on the division of the plurality of battery modules 202, for example, dividing into the first module group A and the second module group B, it is conducive to reduction of the number of doors 203 for the battery compartment to be arranged.

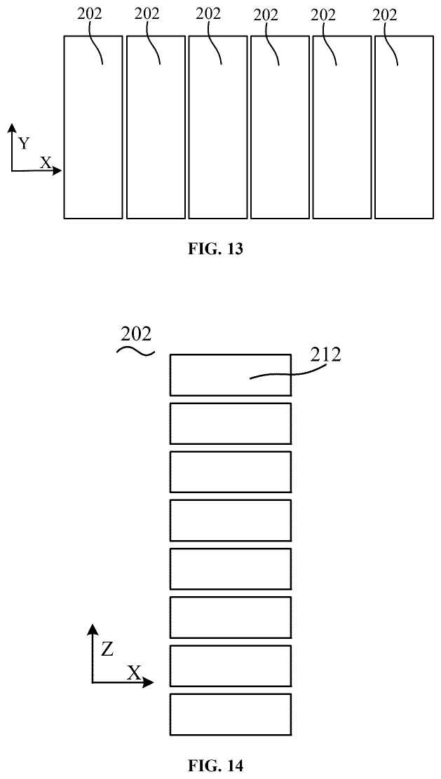

In some other embodiments, referring to FIG. 13, FIG. 13 is a top schematic diagram showing another structure of the plurality of battery modules of the energy storage system provided in some embodiments of the present disclosure. In FIG. 13, all battery modules 202 are arranged at intervals along only the first direction X. In other words, all battery modules 202 are arranged at intervals along only the length direction of the main body 201, and there is only one battery module 202 being arranged in the width direction of the main body 201.

In this way, any two of the plurality of doors 203 for the battery compartment do not directly face each other in the second direction Y, and each door 203 for the battery compartment corresponds to and faces towards at least one respective battery module of the plurality of battery modules 202 in the second direction Y. In this way, it is also conducive to reduction of the number of doors 203 for the battery compartment to be arranged.

Moreover, all battery modules 202 are arranged at intervals along only the length direction of the main body 201, and there is only one battery module 202 being arranged in the width direction of the main body 201. In this way, the volume of individual battery module 202 can be increased. Firstly, the number of cells that each battery module 202 can contain can be increased, thereby increasing the capacity of each battery module 202. Secondly, the number of battery modules 202 that need to be arranged in the battery compartment 211 can reduced, thereby reducing the layout space left between adjacent battery modules 202 in the battery compartment 211, which is conducive to further increase of the total capacity of battery modules 202 that the battery compartment 211 can accommodate, thereby increasing the energy storage density of the energy storage system.

It is noted that in FIG. 13, the battery compartment 211 accommodating only 6 battery modules 202 arranged at intervals along the first direction X is taken as an example, and embodiments of the present disclosure do not limit the number of the battery modules 202 arranged at intervals along the first direction X in the battery compartment 211, as long as these battery modules 202 can be arranged in the battery compartment 211.

It is noted that any two of the plurality of doors 203 for the battery compartment may be arranged on a same side of two sides of the main body perpendicular to the second direction Y, or may be arranged on the two sides of the main body perpendicular to the second direction Y, respectively.

Referring to FIG. 13 and FIG. 10, when all battery modules 202 are arranged at intervals along only the first direction X, all doors 203 for the battery compartment are arranged on a same side of the main body perpendicular to the second direction Y. In this way, the main body 201 is designed to have doors on a single side in the second direction Y. For any main body 201, in the second direction Y, only the side of the main body 201 on which the plurality of doors 203 for the battery compartment are hinged to the main body 201 needs reserved space, so that the doors 203 for the battery compartment can be opened. The other side of the main body 201 on which no door 203 for the battery compartment is hinged to the main body 201 does not need reserved space. In this way, the adjacent two main bodies 201 can be designed back-to-back. In other words, in the second direction Y, the sides of the adjacent two main bodies 201 on which no door 203 for the battery compartment is hinged to the main bodies 201 may abut each other, and opening of the door 203 for the battery compartment of the adjacent two main bodies 201 will not be affected. Therefore, the distance between the adjacent two main bodies 201 can be effectively shorten, which is conducive to arrangement of more main bodies 201 in the limited layout space to increase arrangement density of a plurality of main bodies 201.

It is noted that in the above embodiments, the number of doors 203 for the battery compartment to be arranged can be reduced at least in the following two ways. In the first aspect, the plurality of battery modules 202 arranged in the battery compartment 211 are divided into several module groups. In the second aspect, at least one door 203 for the battery compartment that directly face one or more battery modules 202 in the second direction Y is provided. Moreover, due to the fact that the doors 203 for the battery compartment are hinged to the main body 201 and the hinge joints between the doors 203 for the battery compartment and the main body 201 will occupy the layout space in the main body 201, reduction of the number of doors 203 for the battery compartment to be arranged can lead to reduction of the reserved space in the main body 201 for the hinge connection of the doors 203 for the battery compartment, thereby increasing the space in the main body 201 for installing the battery modules 202 to further increase the integration density of the battery modules 202.

The following will provide a more detailed description of the embodiments of the present disclosure in conjunction with the accompanying drawings. It should be noted that the above embodiments are applicable to the subsequent described embodiments.

In some embodiments, in the first direction X, the main body 201 has a length ranged from 5.5 m to 6.6 m, such as 5.58 m, 5.69 m, 6.35 m, 6.58 m, or the like. In the second direction Y, the main body 201 has a width ranged from 2.1 m to 2.5 m, such as 2.13 m, 2.25 m, 2.3 m, 2.35 m, 2.4 m, 2.438 m, 2.485 m, or the like. In the third direction Z, the main body 201 has a height ranged from 2.1 m to 3 m, such as 2.18 m, 2.25 m, 2.3 m, 2.4 m, 2.5 m, 2.6 m, 2.7 m, 2.8 m, 2.896 m, 2.973 m, or the like. In some embodiments, the main body 201 may be composed of a 20-foot container.

In some embodiments, the total capacity of all battery modules 202 in the energy storage system ranges from 4 MWh to 6 MWh, such as 4 MWh, 4.53 MWh, 5 MWh, 5.016 MWh, 5.32 MWh, 5.5 MWh, 5.7 MWh, or the like.

In some embodiments, the plurality of doors 203 for the battery compartment may be folding doors. In this way, the opening manner of the folding doors is conducive to the flexible adjustment of the opening degree of the doors 203 for the battery compartment, no matter how many battery modules 202 that directly face an individual door 203 for the battery compartment in the second direction Y. Therefore, the size of an area of any battery module 202 exposed from the doors 203 for the battery compartment, as well as the number of the battery modules 202 exposed from the doors 203 for the battery compartment, can be flexibly adjusted, thereby improving the convenience for operators in installing, inspecting, or repairing the battery modules.

In some embodiments, each of the plurality of doors 203 for the battery compartment has a limiting and locking device. When a door 203 for the battery compartment is opened, the overall structure consisting of the door 203 for the battery compartment, hinges of the door 203 for the battery compartment, and the limiting and locking device can withstand a load of at least 0.6 KN and withstand it for not less than 30 minutes.

In some embodiments, the plurality of doors 203 for the battery compartment are fireproof doors with a fire resistance duration of not less than 1 hour.

In some embodiments, the battery compartment 211 accommodates 4 to 8 battery modules 202 arranged at intervals along the first direction X, and each battery module 202 includes 6 to 10 battery packs 212 stacked along a third direction, where the third direction Z refers to a height direction of the energy storage system 200.

As an example, referring to FIG. 10, the battery compartment 211 accommodates 6 battery modules 202 arranged at intervals along the first direction X. Referring to FIG. 11 and FIGS. 14 to 16, each battery module 202 includes 8 battery packs 212 stacked along a third direction, where the third direction Z refers to a height direction of the energy storage system 200.

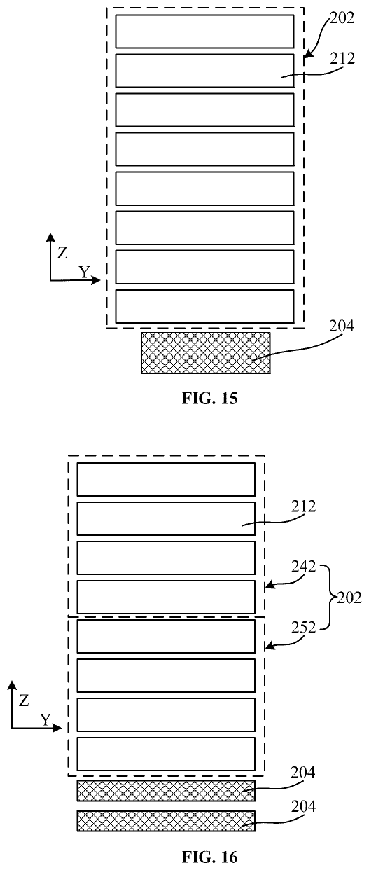

It is noted that in FIG. 11, only 2 battery modules 202 spaced from each other along the first direction X and only 2 battery packs 212 of each battery module 202 are illustrated. Moreover, FIG. 14 is a sectional schematic diagram of a structure of a battery module of the energy storage system provided in some embodiments of the present disclosure. FIG. 15 is a sectional schematic diagram showing a structure of a battery module and a high-voltage compartment of the energy storage system provided in some embodiments of the present disclosure. FIG. 16 is a sectional schematic diagram showing another structure of a battery module and a high-voltage compartment of the energy storage system provided in some embodiments of the present disclosure. It is noted that in order to clearly illustrate the layout of the plurality of battery packs 212 of each battery module 202, as well as the positional relationship between the battery module 202 and the high-voltage compartment 204, FIGS. 14 to 16 show simple drawings of a battery module 202, and FIGS. 15 and 16 show simple drawings of the high-voltage compartment 204.

In some embodiments, referring to FIG. 10, in addition to the plurality of doors 203 for the battery compartment, the energy storage system 200 further includes a plurality of doors for electrical compartment (not shown in the drawings) arranged at least on one of the two sides of the main body perpendicular to the first direction X.

In some embodiments, referring to FIG. 10, in addition to the battery compartment 211 configured to accommodate the plurality of battery modules 202, the main body 201 further includes an electrical compartment 241 configured to accommodate electrical equipment. The battery compartment 211 and the electrical compartment 241 may be arranged along the first direction X, and the electrical compartment 241 may be configured to accommodate at least one of a fire protection device (not shown in the drawings), an electrical integrated cabinet (not shown in the drawings), and a liquid cooling unit (not shown in the drawings). Therefore, the plurality of doors for electrical compartment may be arranged on a side of the electrical compartment 241 away from the battery compartment 211 in the first direction X.

It is noted that in FIG. 10, dashed lines are used to indicate the approximate locations of the battery compartment 211 and the electrical compartment 241 in the main body 201.

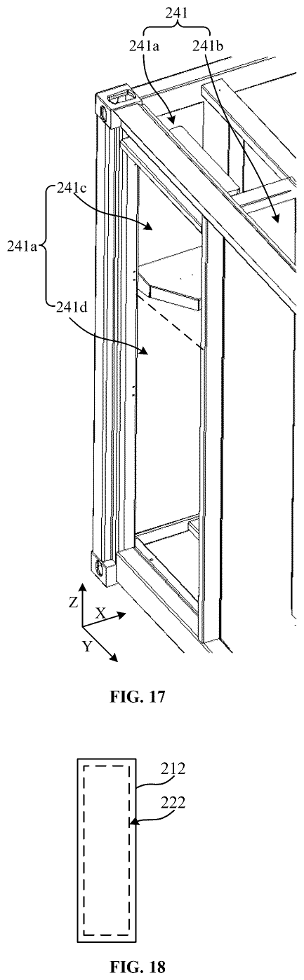

In some embodiments, referring to FIG. 17, FIG. 17 is a perspective schematic diagram of a local structure of the electrical compartment of the energy storage system provided in some embodiments of the present disclosure. The electrical compartment 241 includes a first compartment 241a and a second compartment 241b arranged along the second direction Y, the first compartment 241a is configured to accommodate the fire protection device and the electrical integrated cabinet, and the second compartment 241b is configured to accommodate the liquid cooling unit. Based on this, the plurality of doors for electrical compartment may include a first door for electrical compartment (not shown in the drawings) arranged on a side of the first compartment 241a away from the battery compartment 211 in the first direction X (referring to FIG. 10) and a second door for electrical compartment (not shown in the drawings) arranged on a side of the second compartment 241b away from the battery compartment 211 in the first direction X.

In some embodiments, referring to FIG. 17, the first compartment 241a may further include an upper compartment 241c and a lower compartment 241d arranged along the third direction Z. A cooling device is installed in the upper compartment 241c, and the lower compartment 241d is used to accommodate the electrical integrated cabinet (not shown in the drawings).

In this way, the cold air in the upper compartment 241c that has been cooled by the cooling device flows downwards to the lower compartment 241d, and then can enter the electrical integrated cabinet to cool down the interior of the electrical integrated cabinet. The hot air inside the electrical integrated cabinet can enter the lower compartment 241d, and further flow upwards to the upper compartment 241c to be cooled down using the cooling device. In this way, a circulating exchange of cold and hot air flow can be achieved, thereby further improving the overall heat dissipation effect of the electrical integrated cabinet.

In some embodiments, the cooling device may be an air conditioner.

It is noted that in FIG. 17, the upper compartment 241c and the lower compartment 241d are roughly divided by dashed lines.

In some embodiments, referring to FIGS. 14 to 16, each battery module of the plurality of battery modules 202 may include a plurality of battery packs 212 stacked along a third direction Z, where the third direction refers to a height direction of the energy storage system 200.

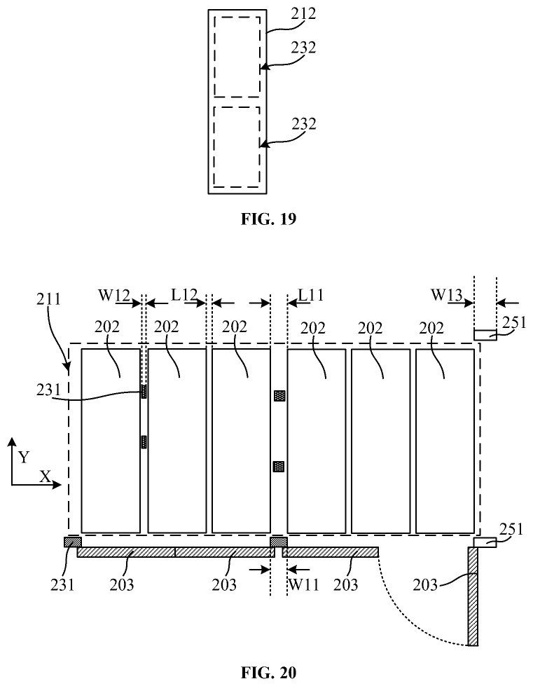

In some embodiments, referring to FIG. 18, each battery pack of the plurality of battery packs 212 includes a single first storage battery module 222. In some other embodiments, referring to FIG. 19, each battery pack of the plurality of battery packs 212 includes two second storage battery modules 232 arranged along the second direction Y.

It is noted that in FIGS. 14 to 16, a battery module 202 including 8 battery packs 212 stacked along the third direction is taken as an example. In practice, the number of the battery packs 212 contained in each battery module 202 may be flexibly adjusted according to the layout space of each battery module 202. FIG. 18 is a top schematic diagram showing a structure of a battery pack of the energy storage system provided in some embodiments of the present disclosure. FIG. 19 is a top schematic diagram showing another structure of a battery pack of the energy storage system provided in some embodiments of the present disclosure. In FIG. 18, the approximate position of the first storage battery module 222 in a battery pack 212 is illustrated by a dashed box, and in FIG. 19, the approximate positions of the second storage battery modules 232 in a battery pack 212 are illustrated by dashed boxes.

In some embodiments, a first mounting position extending along the second direction Y may be designed in each battery pack 212, and the first storage battery module 222 is arranged in the first mounting position. In some embodiments, two second mounting positions arranged along the second direction Y may be designed in each battery pack 212, with each second storage battery module 232 being arranged in a respective second mounting position. In addition, the first storage battery module 222 includes a plurality of cells electrically connected in series or in parallel, and each of the second storage battery modules 232 also includes a plurality of cells electrically connected in series or in parallel, except that the number of the cells of the first storage battery module 222 is different from the number of the cells of each of the second storage battery modules 232.

It should be noted that in the embodiments of the present disclosure, there are no restrictions on the arrangement of the plurality of cells in the first storage battery module 222. The first storage battery module 222 may be a modular storage battery module or a non-modular storage battery module. Similarly, in the embodiments of the present disclosure, there are no restrictions on the arrangement of the plurality of cells in each of the second storage battery modules 232. Each of the second storage battery modules 232 may be a modular storage battery module or a non-modular storage battery module.

In some embodiments, referring to FIG. 10, the main body 201 includes a plurality of brackets 221 and a plurality of columns 231 defining accommodating space in the main body 201. In the third direction Z, each column of the plurality of columns 231 has two respective brackets of the plurality of brackets 221 mounted at two ends of the each column, respectively, and corresponds to a respective door for the battery compartment of the plurality of doors 203 for the battery compartment having a lateral edge hinged to the each column 231. The third direction Z refers to a height direction of the energy storage system 200.

It is noted that there is one respective column 231 installed at the hinge between each door 203 for the battery compartment and the main body 201. The plurality of columns 231 are not only used to strengthen the overall support strength of the main body 201 to prevent deformation of the main body 201, but also to achieve the hinge connection between the doors 203 for the battery compartment and the main body 201. In addition, the energy storage system provided in embodiments of the present disclosure is conducive to reduction of the number of the doors 203 for the battery compartment to be arranged, thereby reducing the number of the columns 231, increasing the space for installing the battery modules 202 in the main body 201, and further increasing the integration density of the battery modules 202.

In some embodiments, referring to FIG. 10, the main body 201 includes 12 brackets 221, of which 4 brackets 221 extend along the first direction X, 4 brackets 221 extend along the second direction Y, and 4 brackets 221 extend along the third direction Z. These 12 brackets 221 may be considered as the 12 edges of a rectangular prism.

In some embodiments, referring to FIGS. 20 to 23, in the first direction X, a first distance L11 between each two adjacent battery modules of the plurality of battery modules 202 that are separated by a respective column of the plurality of columns 231 and correspond to different doors 203 for the battery compartment, respectively, is greater than or equal to a second distance L12 between each two adjacent battery modules of the plurality of battery modules 202 that are not separated by any column.

In the second direction Y, when an individual door 203 for the battery compartment corresponds to and faces towards more than 1 battery module 202, a respective battery module 202 closest to the hinge between a door 203 for the battery compartment and a column 231 directly faces an edge of the door 203 for the battery compartment. When another battery module 202 adjacent to the respective battery module 202 directly faces another door 203 for the battery compartment, the distance between these two adjacent battery modules 202 is the first distance L11. To ensure that the whole battery module 202 can be exposed when a door 203 for the battery compartment is opened, for easy installation, inspection, and maintenance of the battery module 202, the first distance L11 directly faces a corresponding column 231 in the second direction Y, and the magnitude of the first distance L11 may vary with a width of the corresponding column 231 in the first direction X. Moreover, the distances between other adjacent battery modules 202, i.e. the second distances L12, do not correspond to the corresponding column 231 in the second direction Y. Therefore, the second distances L12 only are reserved for the components that need to be arranged between the adjacent battery modules 202, such as the installation space for the brackets.

Therefore, the first distance L11 is designed to be greater than or equal to the second distance L12, which is conducive to increase of the width of the corresponding column 231 in the first direction X, thereby improving the support strength of the corresponding column 231 on the brackets 221, and reducing the distances between the adjacent battery modules 202 that are not separated by any column, i.e. the magnitude of the second distances L12. In this way, the number of battery modules 202 that can be arranged in the limited layout space of the battery compartment 211 can be increased, in order to further improve the integration density of the battery components 202 in the battery compartment 211.

In some embodiments, the support strength of the brackets 221 is very high, and the requirement for the support strength of the columns 231 is relatively low, then the first distance L11 may be equal to the second distance L12. In other words, any two adjacent battery modules 202 may be arranged compactly, in order to improve the integration density of the battery modules 202 in the battery compartment 211. In some other embodiments, the requirement for the support strength of the columns 231 is relatively high, then the first distance L11 may be greater than the second distance L12, which is conducive to improvement of the support strength of the columns 231 on the brackets 221, thereby reducing the magnitude of the second distances L12, in order to ensure relatively high integration density of the battery modules 202 in the battery compartment 211.

In some embodiments, referring to FIGS. 20 to 23, the first distance L11 ranges from 60 mm to 150 mm. When the first distance L11 is greater than 150 mm, the distances between at least some adjacent battery modules 202 are too large, thereby reducing the integration density of the battery modules 202 in the battery compartment 211. When the first distance L11 is less than 60 mm, the widths, in the first direction X, of the columns 231 directly facing the first distances L11 are too small, resulting in that the support strength of the columns 231 cannot meet the requirements. Therefore, the first distance L11 is design to range from 60 mm to 150 mm, thereby ensuring relatively high integration density of the battery modules 202 in the battery compartment 211, and ensuring relatively high support strength of the columns 231.

In some embodiments, the first distance L11 may be 70 mm, 80 mm, 90 mm, 100 mm, 110 mm, 120 mm, 130 mm, 140 mm, or the like.

In some embodiments, referring to FIGS. 20 to 23, the second distance L12 ranges from 30 mm to 150 mm. When the second distance L12 is greater than 150 mm, the distances between at least some adjacent battery modules 202 are too large, thereby reducing the integration density of the battery modules 202 in the battery compartment 211. When the second distance L12 is less than 30 mm, the installation space for components, such as brackets, arranged between adjacent battery modules 202 is reduced, making it impossible for the battery modules 202 to be fixed in the main body 201 using the brackets. Therefore, the second distance L12 is design to range from 30 mm to 150 mm, thereby ensuring relatively high integration density of the battery modules 202 in the battery compartment 211, and ensuring sufficient installation space between adjacent battery modules 202.

In some embodiments, the second distance L12 may be 35 mm, 40 mm, 45 mm, 50 mm, 55 mm, 65 mm, 75 mm, 85 mm, 95 mm, 105 mm, 115 mm, 125 mm, 135 mm, 145 mm, or the like.

In some embodiments, referring to FIG. 20, FIG. 20 is a top schematic diagram of a first local structure of the energy storage system provided in some embodiments of the present disclosure. In the first direction X, each column of the plurality of columns 231 that is hinged with a respective door for the battery compartment of the plurality of doors 203 for the battery compartment has a first width W11, each column of the plurality of columns 231 that is not hinged with any of the plurality of doors 203 for the battery compartment has a second width W12, and the first width W11 is greater than or equal to the second width W12.

It is noted that not each column of the plurality of columns 231 is hinged with a respective door for the battery compartment of the plurality of doors 203 for the battery compartment. Some columns 231 are only used to strengthen the overall support strength of the main body 201 and to prevent deformation of the main body 201. Based on this, the columns 231 hinged with the doors 203 for the battery compartment not only needs to provide some support for the main body 201, but also needs to bear the force exerted by the doors for the battery compartment. Therefore, higher requirements are placed on the strength of the columns 231 hinged with the doors 203 for the battery compartment. In other words, the columns 231 hinged with the doors 203 for the battery compartment not only need to support the brackets 221, but also need to support the doors 203 for the battery compartment. Therefore, the first width W11 is designed to be greater than or equal to the second width W12, which is conducive to improvement of the support strength of the columns 231 hinged with the doors 203 for the battery compartment, and to reduction of widths of the columns 231 that are not hinged with any door 203 for the battery compartment, i.e. the second widths W12. In this way, the production cost of the main body 201 can be reduced, and the total layout space occupied by all columns 231 in the main body 201 can be reduced.

It should be noted that in order to distinguish the columns 231 hinged with doors 203 for the battery compartment from the columns 231 that are not hinged with any door 203 for the battery compartment, in FIG. 19, these two types of columns are drawn in different ways. In addition, in the embodiments of the present disclosure, the number and specific arrangement of the columns 231 that are not hinged with any door 203 for the battery compartment in the main body 201 are not limited, and can be adjusted according to actual situations.

In some embodiments, referring to FIG. 20, the first width W11 ranges from 60 mm to 150 mm, and the second width W12 ranges from 22 mm to 142 mm. It should be noted that each first width W11 corresponds to a respective first distance L11, then the each first width W11 and the respective first distance L11 have a same valuing range. In addition, when the second width W12 is greater than 142 mm, not only the production cost of the main body 201 is too high, but also causes the total layout space occupied by all columns 231 in the main body 201 to be too large, and the installation space reserved for the brackets in the second distances L12 is too small. When the second width W12 is less than 52 mm, the support strength of the columns 231 is too small, providing not sufficient support for the main body 201. Therefore, the second width W12 is designed to range from 52 mm to 142 mm, which is conducive to ensuring that the columns 231 supports the main body 201, and reducing the production cost of the main body 201. Moreover, the total layout space occupied by all columns 231 in the main body 201 can be reduced, and sufficient installation space can be reserved for the brackets.

In some embodiments, the first width W11 may be 70 mm, 80 mm 90 mm 100 mm, 110 mm, 120 mm, 130 mm, 140 mm, or the like.

In some embodiments, the second width W12 may be 27 mm, 32 mm, 37 mm, 42 mm, 47 mm, 57 mm, 67 mm, 77 mm, 87 mm, 97 mm, 107 mm, 117 mm, 127 mm, 137 mm, or the like.

In some embodiments, referring to FIGS. 10 and 20, the main body 201 may further include 4 main columns 251 for forming 8 vertices of the main body 201, and two ends of each main column 251 along the third direction form 2 respective vertices of the main body 201 Z. In the first direction X, each main column 251 has a third width W13 greater than or equal to the first width W11.

In some embodiments, referring to FIG. 20, the third width W13 ranges from 80 mm to 170 mm, which is conducive to improving the overall support strength of the main body 201 using the 4 main columns 251.

In some embodiments, the third width W13 may be 90 mm, 100 mm, 110 mm, 120 mm, 130 mm, 140 mm, 150 mm, 160 mm, or the like.

In some embodiments, the doors 203 for the battery compartment corresponding to a side of the battery compartment 211 away from the electrical compartment 241 in the first direction X may be hinged with main columns 251, respectively. In other words, the main columns 251 corresponding to the side of the battery compartment 211 away from the electrical compartment 241 in the first direction X may be hinged with doors 203 for the battery compartment.

In some embodiments, referring to FIGS. 20 to 23, in the second direction Y, each door for the battery compartment of the plurality of doors 203 for the battery compartment corresponds to and faces towards N respective battery modules of the plurality of battery modules 202, where N is a rational number greater than or equal to 1. In the second direction, a number of battery modules of the plurality of battery modules 202 corresponding to one respective door for the battery compartment of the plurality of doors 203 for the battery compartment is different from a number of battery modules of the plurality of battery modules 202 corresponding to another door for the battery compartment of the plurality of doors 203 for the battery compartment, or in the second direction, a number of battery modules of the plurality of battery modules 202 corresponding to one respective door for the battery compartment of the plurality of doors 203 for the battery compartment is same as a number of battery modules of the plurality of battery modules 202 corresponding to another door for the battery compartment of the plurality of doors 203 for the battery compartment.

In some embodiments, N may be 1. 1.5, 2, or the like.

In the following, the correspondence between the doors 203 for the battery compartment and the battery modules 202 will be described in detail.

In some embodiments, referring to FIGS. 10 and 20, in the second direction Y, each door 203 for the battery compartment corresponds to and faces towards 1.5 respective battery modules 202. In order words, in the first direction X, 3 adjacent battery modules 202 share 2 doors 203 for the battery compartment.

In some embodiments, any one of the plurality of doors 203 for the battery compartment may correspond to and face towards 1.5 battery modules 202.

In some embodiments, referring to FIG. 20, when each door 203 for the battery compartment corresponds to and faces towards 1.5 respective battery modules 202 in the second direction Y, each two adjacent doors 203 for the battery compartment shared by 3 respective adjacent battery modules 202 have inverse opening directions in the first direction X. In order words, one of the each two adjacent doors 203 for the battery compartment is pivoted clockwise to expose battery modules 202, and the other one is pivoted counterclockwise to expose battery modules 202.

For example, the 3 adjacent battery modules 202 in the first direction X are referred to as the first battery module, the second battery module, and the third battery module in sequence. Each of the first and third battery modules directly faces one respective door 203 for the battery compartment of 2 adjacent doors 203 for the battery compartment, and the second battery module directly faces a portion of one of the 2 adjacent doors 203 for the battery compartment and directly faces a portion of the other one of the 2 adjacent doors 203 for the battery compartment. In this way, when it is necessary to install, inspect, and repair the first battery module or the third battery module, only one of the 2 adjacent doors 203 for the battery compartment needs to be opened. When installing, inspecting, and repairing the second battery module, both the 2 adjacent doors 203 for the battery compartment need to be opened to expose the complete second battery module.

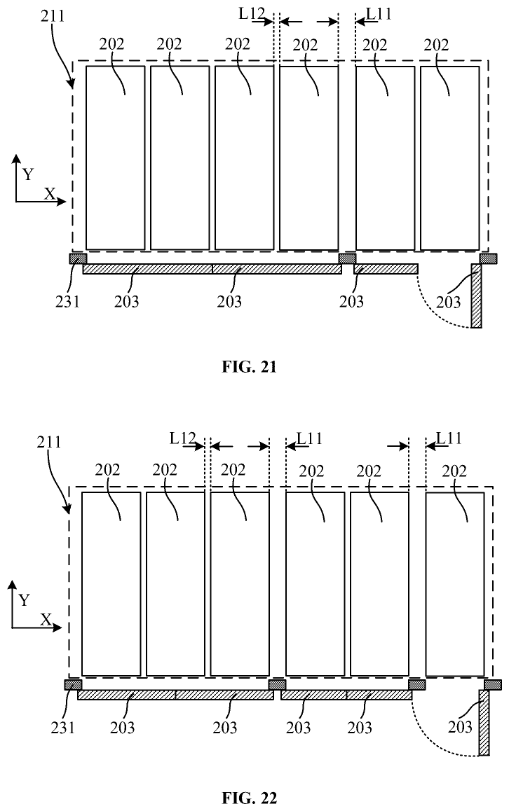

In some other embodiments, referring to FIG. 21, FIG. 21 is a top schematic diagram of a second local structure of the energy storage system provided in some embodiments of the present disclosure. In the second direction Y, each door 203 for the battery compartment corresponds to and faces towards 2 respective battery modules 202. In order words, in the first direction X, 2 adjacent battery modules 202 share 1 door 203 for the battery compartment.

In some embodiments, any one of the plurality of doors 203 for the battery compartment may correspond to and face towards 2 battery modules 202.

Each two adjacent doors 203 for the battery compartment may have the same or inverse opening directions. When having the same opening direction, the two adjacent doors 203 for the battery compartment are pivoted clockwise or counterclockwise to expose battery modules 202. When having inverse opening directions, one of the two adjacent doors 203 for the battery compartment is pivoted clockwise to expose battery modules 202, and the other one is pivoted counterclockwise to expose battery modules 202.

It is noted that when each door 203 for the battery compartment corresponds to and faces towards 2 respective battery modules 202, each two adjacent doors 203 for the battery compartment have the same opening direction, which enable these two doors 203 for the battery compartment to open concurrently without interfering with each other.

In some still other embodiments, referring to FIG. 22, FIG. 22 is a top schematic diagram of a third local structure of the energy storage system provided in some embodiments of the present disclosure. Each of some doors 203 for the battery compartment of the plurality of doors 203 for the battery compartment corresponds to and faces towards 1.5 respective battery modules 202, and each of the remaining doors 203 for the battery compartment of the plurality of doors 203 for the battery compartment corresponds to and faces towards 1 respective battery module 202. In other words, 3 adjacent battery modules 202 in the first direction X may share 2 doors 203 for the battery compartment, or one battery module 202 may correspond to one door 203 for the battery compartment. Each two adjacent doors 203 for the battery compartment may have the same or inverse opening directions.

For example, referring to FIG. 22, when there are 6 battery modules 202 arranged along the first direction X in the energy storage system, 3 battery modules 202 share 2 doors 203 for the battery compartment, and each of the remaining 3 battery modules 202 correspond to one respective door 203 for the battery compartment.

In some embodiments, the energy storage system includes at least 3 doors 203 for the battery compartment, and each two adjacent doors 203 for the battery compartment may have the same or inverse opening directions. For example, two adjacent doors of the 3 doors 203 for the battery compartment have a same opening direction, and the remaining one has an opening direction opposite to the opening direction of the other two doors. In some other embodiments, all doors 203 for the battery compartment have a same opening direction. In this way, any two doors 203 for the battery compartment can be opened concurrently without interfering with each other.

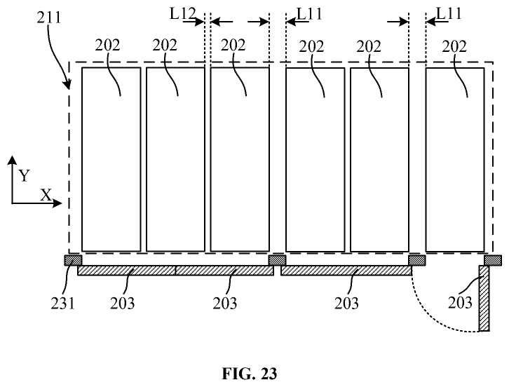

In some yet other embodiments, referring to FIG. 23, FIG. 23 is a top schematic diagram of a fourth local structure of the energy storage system provided in some embodiments of the present disclosure. Each of some doors 203 for the battery compartment of the plurality of doors 203 for the battery compartment corresponds to and faces towards 1.5 respective battery modules 202, each of some doors 203 for the battery compartment of the plurality of doors 203 for the battery compartment corresponds to and faces towards 2 respective battery modules 202, and each of the remaining doors 203 for the battery compartment of the plurality of doors 203 for the battery compartment corresponds to and faces towards 1 respective battery module 202. For example, when there are 6 battery modules 202 arranged along the first direction X in the energy storage system, 3 battery modules 202 share 2 doors 203 for the battery compartment, 2 battery modules 202 share 1 door 203 for the battery compartment, and the remaining 1 battery modules 202 correspond to one door 203 for the battery compartment.

In some more embodiments, any one of the plurality of doors 203 for the battery compartment may correspond to and face towards 1 battery module 202.

The doors 203 for the battery compartment of the plurality of doors 203 for the battery compartment each corresponding to and facing towards 1.5 respective battery modules 202 are referred to as first doors, the doors 203 for the battery compartment of the plurality of doors 203 for the battery compartment each corresponding to and facing towards 2 respective battery modules 202 are referred to as second doors, and the doors 203 for the battery compartment of the plurality of doors 203 for the battery compartment each corresponding to and facing towards 1 respective battery module 202 are referred to as third doors, then the plurality of doors 203 for the battery compartment in the energy storage system may be doors of one type, two types or all types of the first, second, and third doors. Moreover, the opening direction of each door 203 for the battery compartment may be flexibly adjusted as needed.

The plurality of doors 203 for the battery compartment in the energy storage system may be of a same type. In other words, in the second direction Y, a number of battery modules of the plurality of battery modules 202 corresponding to one respective door for the battery compartment of the plurality of doors 203 for the battery compartment is same as a number of battery modules of the plurality of battery modules 202 corresponding to another door for the battery compartment of the plurality of doors 203 for the battery compartment. In this way, the plurality of doors 203 for the battery compartment can have a same size specification, which is beneficial for reducing the production cost of the plurality of doors 203 for the battery compartment.

Moreover, in the second direction Y, the greater the number of battery modules 202 corresponding to one respective door for the battery compartment of the plurality of doors 203 for the battery compartment is, the smaller the number of the plurality of doors 203 for the battery compartment needed in the energy storage system, and the smaller the space reserved for the hinge connection of the plurality of doors 203 for the battery compartment with the main body 201. In this way, the space in the main body 201 for installing the battery modules 202 can be increased, thereby further increasing the integration density of the battery modules 202.

In some embodiments, referring to FIGS. 11, 15 and 16, the energy storage system 200 may further include a plurality of high-voltage compartments 204 arranged below the plurality of battery modules 202 in a third direction Z and electrically connected to the plurality of battery modules 202, where the third direction Z refers to a height direction of the energy storage system 200.

In some embodiments, referring to FIG. 15, each battery module 202 corresponds to one respective high-voltage compartment of the plurality of high-voltage compartments 204. In some other embodiments, referring to FIG. 16, each battery module 202 corresponds to two respective high-voltage compartments of the plurality of high-voltage compartments 204.

It is noted that each battery module 202 includes a plurality of battery packs 212 stacked along the third direction. When each battery module 202 includes a relatively large number of battery packs 212, considering that each high-voltage compartment 204 has respective rated power parameters, each battery module 202 may be designed to correspond to two respective high-voltage compartments 204, in order to prevent the inability of a high-voltage compartment 204 to function properly, when a battery module 202 is electrically connected to only this high-voltage compartment 204, due to an excessive number of battery packs 212 contained in the battery module 202.

In some embodiments, referring to FIG. 15, when each battery module 202 corresponds to one respective high-voltage compartment 204 and a plane perpendicular to the third direction Z is used as a projection plane, an orthographic projection of the respective high-voltage compartment 204 on the projection plane overlaps with an orthographic projection of the each battery module 202 on the projection plane. In some embodiments, the orthographic projection of the respective high-voltage compartment 204 on the projection plane may be centered on the orthographic projection of the each battery module 202 on the projection plane.

In some other embodiments, referring to FIG. 16, each battery module of the plurality of battery modules 202 corresponds to two respective high-voltage compartments of the plurality of high-voltage compartments 204 and includes a first submodule 242 and a second submodule 252 arranged along the third direction Z. The first submodule 242 is electrically connected to one high-voltage compartment 204 of the two respective high-voltage compartments, and the second submodule 252 is electrically connected to an other high-voltage compartment 204 of the two respective high-voltage compartments.

It is noted that each of the first submodule 242 and the second submodule 252 includes a plurality of battery packs 212. Embodiments of the present disclosure do not limit the number of battery packs 212 of the first submodule 242 and the number of battery packs 212 of the second submodule 252.

In some embodiments, each battery module 202 includes 8 battery packs 212 stacked along the third direction. In the third direction Z, these 8 battery packs 212 include 4 upper long packs and 4 lower long packs. The first submodule 242 includes the 4 upper long packs, and the second submodule 252 includes the 4 lower long packs.

The two respective high-voltage compartments 204 may be arranged in the following ways: referring FIG. 16, the two respective high-voltage compartments 204 may be stacked along the third direction Z, or may be arranged to space from each other along the second direction, or may be arranged to space from each other along the first direction. It is noted that when a plane perpendicular to the third direction Z is used as a projection plane, the orthographic projections of the two respective high-voltage compartments 204 on the projection plane may both be located in the orthographic projection of the each battery module 202 on the projection plane.

In summary, on the one hand, the plurality of battery modules 202 in the battery compartment 211 are arranged at intervals along a same direction, i.e. the first direction X or the second direction Y. In this way, it is conducive to flexible adjustment of the number of battery modules 202 arranged at intervals along the first direction X or the second direction Y based on the space used for arranging the battery modules 202 in the battery compartment 211, in order to increase the integration density of the battery modules 202 in the battery compartment 211. Moreover, the plurality of battery modules 202 located in the battery compartment 211 are arranged at intervals along a same direction. In other words, the arrangement of all battery modules 202 has only one arrangement direction, i.e. the first direction X or the second direction Y. Based on this, each door for the battery compartment of the plurality of doors 203 for the battery compartment is arranged on one respective side of two sides of the battery modules 202 opposite to each other along the second direction Y, and in the second direction Y, each door 203 for the battery compartment corresponds to and faces towards at least one respective battery module of the plurality of battery modules 202, and at least some of the doors 203 for the battery compartment will not directly face to each other along the second direction Y, which is conducive to reduction of the number of the doors 203 for the battery compartment. On the other hand, each door 203 for the battery compartment is hinged to the main body 201, and the hinge joint between each door 203 for the battery compartment and the main body 201 will also occupy the layout space in the main body 201. Therefore, reduction of the number of the doors 203 for the battery compartment to be arranged is beneficial for reducing the reserved space in the main body 201 for hinge connection of the doors 203 for the battery compartment, thereby increasing the space used for installing battery modules 202 in the main body 201, and further increasing the integration density of battery modules 202.

Those having ordinary skill in the art shall understand that the above embodiments are exemplary implementations for realizing the present disclosure. In practice, any person skilled in the art to which the embodiments of the present disclosure belong may make any modifications and changes in forms and details without departing from the scope of the present disclosure. Therefore, the patent scope of protection of the present disclosure shall still be subject to the scope limited by the appended claims.

What is claimed is:

1. An energy storage system, comprising:
a main body, including an equipment compartment and a battery compartment arranged in a length direction of the energy storage system, wherein the equipment compartment is configured to accommodate at least one of a fire protection device, an electrical integrated cabinet, and a liquid cooling unit; and
a plurality of battery modules arranged in the battery compartment, wherein the battery compartment is configured to accommodate the plurality of battery modules, the plurality of battery modules are arranged at intervals along the length direction, and each battery module of the plurality of battery modules extends along a width direction of the energy storage system.

2. The energy storage system according to claim 1, wherein in the length direction, the equipment compartment has a first size, the battery compartment has a second size, and a ratio of the first size to the second size ranges from 0.06 to 0.16.

3. The energy storage system according to claim 2, wherein the first size ranges from 0.4 m to 0.7 m, and the second size ranges from 4.5 m to 6 m.

4. The energy storage system according to claim 1, wherein in the width direction, a width of one respective battery module of the plurality of battery modules is less than a width of the battery compartment by 100 mm to 250 mm; and
in the length direction, a sum of widths of the plurality of battery modules is less than a length of the battery compartment.

5. The energy storage system according to claim 1, wherein the equipment compartment includes a first compartment and a second compartment arranged along the width direction, the first compartment is configured to accommodate the fire protection device and the electrical integrated cabinet, and the second compartment is configured to accommodate the liquid cooling unit.

6. The energy storage system according to claim 5, wherein the fire protection device and the electrical integrated cabinet are spaced from each other in a height direction of the energy storage system.

7. The energy storage system according to claim 1, further comprising a plurality of high-voltage compartments arranged below the plurality of battery modules in a height direction of the energy storage system and electrically connected to the plurality of battery modules; and
wherein each battery module of the plurality of battery modules corresponds to one or two respective high-voltage compartments of the plurality of high-voltage compartments.

8. The energy storage system according to claim 7, wherein each battery module of the plurality of battery modules corresponds to two respective high-voltage compartments of the plurality of high-voltage compartments and includes a first submodule and a second submodule arranged in the height direction, the first submodule is electrically connected to one high-voltage compartment of the two respective high-voltage compartments, and the second submodule is electrically connected to an other high-voltage compartment of the two respective high-voltage compartments.

9. The energy storage system according to claim 7, wherein each battery module of the plurality of battery modules corresponds to one respective high-voltage compartment of the plurality of high-voltage compartments and includes a first submodule and a second submodule arranged along the height direction; and
wherein the one respective high-voltage compartment has a first input and output port and a second input and output port arranged on a side of the one respective high-voltage compartment extending perpendicular to the width direction, and the first input and output port and the second input and output port are spaced from each other.

10. The energy storage system according to claim 1, further comprising liquid cooling pipelines arranged on a side of the battery compartment extending perpendicular to the width direction.

11. The energy storage system according to claim 10, wherein in a height direction of the energy storage system, each battery module of the plurality of battery modules has a bottom side and a top side;
wherein the liquid cooling pipelines include a main inflow pipeline and a main outflow pipeline, and in the height direction, one of the main inflow pipeline and the main outflow pipeline is arranged on the bottom side and has a part facing towards the bottom side, and an other of the main inflow pipeline and the main outflow pipeline is arranged on the top side and has a part facing towards the top side; and
wherein the main inflow pipeline has an inlet, the main outflow pipeline has an outlet, and the inlet and the outlet are connected to the liquid cooling unit.

12. The energy storage system according to claim 11, wherein the liquid cooling unit includes a first portion and a second portion arranged along the height direction, the first portion includes a plurality of air exhaust devices, and the second portion is connected with the inlet of the main inflow pipeline and the outlet of the main outflow pipeline.

13. The energy storage system according to claim 12, wherein the second portion has a sidewall extending perpendicular to the length direction, there is a gap between the sidewall and a bottom of the main body in the height direction, and the gap is formed on a side of the main body perpendicular to the length direction; and
wherein the energy storage system further includes a decorative panel configured to block the gap.

14. The energy storage system according to claim 1, wherein each of the plurality of battery modules includes a plurality of battery units stacked along a height direction of the energy storage system.

15. The energy storage system according to claim 14, further comprising a plurality of brackets configured to carry battery units of the plurality of battery modules and extending in the width direction, wherein each battery unit of the battery units is arranged on two respective brackets of the plurality of brackets spaced from each other in the length direction.

16. The energy storage system according to claim 1, wherein a plurality of cable grooves are defined in the main body and include bottom cable grooves that are defined at a bottom of the battery compartment in a height direction of the energy storage system.

17. The energy storage system according to claim 16, wherein the bottom cable grooves include first cable grooves and second cable grooves, and the first cable grooves are independent of the second cable grooves;
the energy storage system further includes:
first cables arranged in the first cable grooves, wherein the first cables are used to conduct dynamic electricity; and
second cables arranged in the second cable grooves, wherein the second cables are used to transmit signals.
